(19) United States
(12) Patent Application Publication
(10) Pub. No.: US 2002/0071141 A1
(43) Pub. Date: Jun. 13, 2002

(54) Image reading device and image reading method

(75) Inventors: Kazuhiko Katakura, Kanagawa (JP); Yasunobu Sakaguchi, Kanagawa (JP)

Correspondence Address: SUGHRUE, MION, ZINN, MACPEAK & SEAS, PLLC, 2100 Pennsylvania Avenue, NW, Washington, DC, 20037-3213, US

(73) Assignee: FUJI PHOTO FILM CO., LTD.

(21) Appl. No.: 09/872,857

(22) Filed: Jun. 4, 2001

(30) Foreign Application Priority Data
Jun. 5, 2000 (JP) 2000-167585

(51) Int. Cl. H04N 1/04

(52) U.S. Cl. 358/474

(57) ABSTRACT

An image reading device and an image reading method are provided which are inexpensive and compact and which can carry out high quality image reading by simple control. An area CCD scanner section, which reads a frame image of a photographic film set at a film carrier, is provided with a reading section and a light source selection. The reading section is formed so as to include a lens unit and an area CCD, and is slidable. The light source unit can selectively emit visible light and infrared light. Focus control is carried out at each of a time of reading a frame image by visible light and a time of reading the frame image by infrared light.

### BACKGROUND OF THE INVENTION

1. Field of the Invention

The present invention relates to an image reading device and an image reading method, and in particular, to an image reading device and an image reading method which read an image of an original by using visible light and infrared light.

2. Description of the Related Art

In recent years, image reading devices have been put into practice which emit illumination light onto a reflection original such as a photographic print or a transmission original such as a photographic film. The light, which is reflected by or transmitted through the original and which carries image information recorded on the original, is received by an image sensor such as a CCD (charge coupled device) or the like such that the image recorded on the original is read. Processings such as various types of correction and the like are carried out on the image data obtained by this reading. Thereafter, image recording onto a recording material such as a photographic printing paper or image display onto a display, or the like is carried out. Such an image reading device has the function of reading an image recorded on an original, as well as functions of recording the image onto a different recording medium such as a print or a CD, displaying the image on a display, and producing prints of high added value due to image synthesis. In addition, the image reading device has the advantage that work is easy due to the improvement in image quality and automatization.

In such an image reading device, a conventional white color light source such as a halogen lamp or the like is used as the light source for illuminating the original. However, in recent years, devices using LED light sources instead of white light sources have come to be used. The LED light source is formed by a large number of LED (light emitting diode) elements, which emit lights of R (red), G (green) and B (blue) colors, being arranged in array form on a printed wiring board.

By using an LED light source, there is no need for a filter for color separation of the white light source, and the structure of the device can be simplified. Further, the setting of conditions, such as the color balance and the like, is more simple.

However, in such an image reading device, in a case in which there is damage such as scratches or the like to the original which is the object of reading, or foreign matter such as fingerprints or dust or the like have adhered to the original, such damage or foreign matter is a cause of problems in image quality of the image data obtained by image reading and the image which is finally obtained.

Thus, conventionally, infrared light is illuminated onto the original which is the object of reading. On the basis of the light which passes through the original, the position of the damage or foreign matter which is a source of deterioration in image quality is detected. On the basis of the results of detection, the image data obtained by image reading by visible light is repaired, and the shadow caused by the damage or foreignmatter is automatically eliminated.

However, with this technique, there is the need to acquire the image data of the original both by infrared light and by visible light as described above. The focus position for infrared light of the imaging lens, which images the transmitted light or the reflected light from the original onto the image sensor, is markedly different than that for visible light. Thus, at the time of image reading by infrared light and at the time of image reading by visible light, in a case in which the positional relationships of the original, the imaging lens and the image sensor are the same, a sharp image cannot be obtained by at least one of the image data obtained by image reading by infrared light and the image data obtained by image reading by visible light. Thus, the elimination of shadows caused by damage or foreign matter as described above cannot be carried out with high accuracy, and as a result, a problem arises in that high quality image data cannot be obtained. This problem may be solved by modifying design of the lens. However, in the environmental point of view, glass material containing lead cannot be used, therefore, it is difficult to solve the problem by designing of the lens.

### SUMMARY OF THE INVENTION

The present invention was developed in order to overcome the above-described drawbacks, and an object of the present invention is to provide an image reading device and an image reading method which can be structured compactly and at a low cost, and which can carry out high quality image reading with simple control.

In order to achieve the above object, an image reading device of the first aspect of the present invention comprises: an illuminating section which emits visible light and infrared light and illuminates an original; an imaging section which images one of light transmitted through the original and light reflected by the original; an image sensor which divides an image imaged by the imaging section into a plurality of pixels and reads the image and outputs the image as image data; a moving section which moves at least one of at least one portion of the imaging section, the image sensor, and the original, in an optical axis direction of the imaging section; and a control section which, at each of a time of reading the image by the visible light and a time of reading the image by the infrared light, controls the moving section such that focus control is carried out by which an imaging position by the imaging section and a reading position of the image sensor coincide.

In accordance with the image reading device of the first aspect, visible light and infrared light are emitted by the illuminating section and are illuminated onto the original. The light which is transmitted through or reflected by the original is imaged by the imaging section. The image, which is imaged by the imaging section, is, by the image sensor, divided into a plurality of pixels and read and output as image data. Examples of the original are transmission originals such as photographic films or the like and reflection originals such as photographic prints or the like. The visible light includes red color light, green color light, and blue color light. The illuminating section may be a light source which is equipped with a white light source such as a halogen lamp and a filter for color separating the white light source, or may be an LED light source, or the like.

In the invention of the first aspect, at each of a time of reading the image by the visible light and a time of reading the image by the infrared light, the moving section is controlled to move at least one of at least one portion of the imaging section, the image sensor, and the original, in an optical axis direction of the imaging section, such that focus control is carried out by which an imaging position by the imaging section and a reading position of the image sensor coincide.

In this way, in accordance with the image reading device of the first aspect, at each of a time of reading the image by the visible light and a time of reading the image by the infrared light, control is effected such that focus control is carried out by which an imaging position by the imaging section and a reading position of the image sensor coincide. Thus, by merely controlling an imaging section, a moving section or the like, which are provided in conventional image reading devices, sharp and clear images can be obtained for both image data obtained by image reading by visible light and image data obtained by image reading by infrared light. The structure can be made compact and low cost, and high quality image reading can be carried out by simple control.

In an image reading device of a second aspect of the present invention, in the first aspect, on the basis of image data obtained by reading the image by the infrared light, the control section detects a position of at least one of scratch (damage) and foreign matter on the original, and on the basis of results of detection, corrects image data obtained by reading the image by the visible light.

In accordance with the image reading device of the second aspect, on the basis of image data obtained by reading the image by the infrared light, the control section detects a position of damage or foreign matter on the original. On the basis of results of detection, the control section corrects the image data obtained by reading the image by the visible light. An example of the method for correcting the image data is a method of obtaining the density values of pixels corresponding to the position of the damage or foreign matter, by interpolation computation using the density values of the surrounding pixels.

In this way, in accordance with the image reading device of the second aspect, the same effects as those of the first aspect are achieved. In addition, the position of damage or foreign matter on the original is detected on the basis of the image data obtained by reading the image by the infrared light, and on the basis of the results of detection, the image data obtained by reading the image by the visible light is corrected. Thus, high quality image data, from which images of damage or foreign matter on the original have been removed, can be obtained.

Depending on the type of the imaging section, the imaging section may have great magnification chromatic aberration or distortion aberration with respect to infrared light. The accurate position of damage or foreign matter on the original cannot be detected from image data obtained by infrared light which is acquired by using such an imaging section.

Thus, in an image reading device of a third aspect of the present invention, in the second aspect, before correction of the image data obtained by reading the image by the visible light, the control section carries out at least one of magnification chromatic aberration correction and distortion aberration correction on the image data obtained by reading the image by the infrared light.

In accordance with the image reading device of the third aspect, before correction of the image data, the control section carries out at least one aberration correction among magnification chromatic aberration correction and distortion aberration correction, on the image data obtained by reading of the image by the infrared light.

In this way, in accordance with the image reading device of the third aspect, the same effects as those of the second aspect of the present invention are achieved. In addition, before correction of the image data, at least one of magnification chromatic aberration correction and distortion aberration correction is carried out on the image data obtained by reading of the image by the infrared light. Thus, regardless of the quality of the optical performance of the imaging section, the accurate position of damage or foreign matter on the original can be detected, and as a result, high quality image data can be obtained.

However, depending on the type of the imaging section, there are cases in which the image positions are offset between the image data obtained by reading the image by infrared light and the image data obtained by reading the image by the visible light. The position of damage or foreign mater on the original, which is detected on the basis of the image data obtained by infrared light by using such an imaging section, does not correspond with the position on the original represented by the image data obtained by visible light. Thus, correction of the image data obtained by visible light cannot be carried out accurately.

Thus, in the image reading device of the fourth aspect of the present invention, in the invention of either of the second or third aspects, before correction of the image data obtained by reading the image by the visible light, the control section detects an image positional offset amount between the image data obtained by reading the image by infrared light and the image data obtained by reading the image by the visible light, and, on the basis of the positional offset amount, corrects one of the image data obtained by reading the image by the infrared light or the image data obtained by reading the image by the visible light such that the positional offset amount becomes minimum.

In accordance with the image reading device of the fourth aspect, before correction of the image data, the control section detects an image positional offset amount between image data obtained by reading the image by infrared light and image data obtained by reading the image by the visible light. On the basis of the positional offset amount, the control section corrects either the image data obtained by reading the image by the infrared light or the image data obtained by reading the image by the visible light, such that the positional offset amount becomes minimum.

In this way, in accordance with the image reading device of the fourth aspect, the same effects as those of the second or third aspects are achieved. In addition, before correction of the image data, the image positional offset amount between image data obtained by reading the image by the infrared light and image data obtained by reading the image by the visible light is detected. On the basis of this positional offset amount, either the image data obtained by reading the image by the infrared light or the image data obtained by reading the image by the visible light is corrected such that the positional offset amount becomes minimum. Thus, the position of damage or foreign matter on the original, which is detected on the basis of the image data obtained by infrared light, can be made to correspond to the position on the image expressed by the image data obtained by visible light. As a result, correction, based on the results of detection of the position of the damage or foreign matter, of the image data obtained by visible light can be carried out accurately.

In the image reading device of the fifth aspect of the present invention, in the fourth aspect, the control section one of detects the positional offset amount in advance, and each time an image is read, corrects, on the basis of the positional offset amount, one of the image data obtained by reading the image by the infrared light and the image data obtained by reading the image by the visible light such that the positional offset amount becomes minimum; and each time an image is read, detects the positional offset amount, and corrects, on the basis of the positional offset amount, one of the image data obtained by reading the image by the infrared light and the image data obtained by reading the image by the visible light such that the positional offset amount becomes minimum.

In accordance with the fifth aspect of the present invention, the control section either (a) detects the positional offset amount in advance, and each time an image is read, corrects, on the basis of the positional offset amount, either the image data obtained by reading the image by the infrared light or the image data obtained by reading the image by the visible light such that the positional offset amount becomes minimum, or (b) each time an image is read, detects the positional offset amount, and corrects, on the basis of the positional offset amount, either the image data obtained by reading the image by the infrared light or the image data obtained by reading the image by the visible light such that the positional offset amount becomes minimum.

In this way, in accordance with the image reading device of the fifth aspect, the same effects as those of the fourth aspect can be achieved. In addition, the positional offset amount is detected in advance, and each time an image is read, on the basis of the positional offset amount, either the image data obtained by reading the image by the infrared light or the image data obtained by reading the image by the visible light is corrected such that the positional offset amount becomes minimum. Or, each time an image is read, the positional offset amount is detected, and, on the basis of the positional offset amount, either the image data obtained by reading the image by the infrared light or the image data obtained by reading the image by the visible light is corrected such that the positional offset amount becomes minimum. Thus, in a case in which the positional offset amount is detected in advance, processing can be carried out faster than in a case in which the positional offset amount is detected each time image reading is carried out. Further, in a case in which the positional offset amount is detected each time an image is read, correction of the image data obtained by visible light can be carried out with high accuracy even in a system in which, each time an image is read, there is a dispersion in the positional offsets expressed by the positional offset amounts.

In the image reading device of the sixth aspect of the present invention, in any of the first through fifth aspects, the control section acquires in advance a focus position for a time of image reading by the visible light and a focus position for a time of image reading by the infrared light, by controlling the illuminating section and the moving section such that focus control in a case using each the visible light and the infrared light is carried out, and controls the moving section such that, at each time reading the image recorded on the original by respective visible light and the infrared light, at least one of at least one portion of the imaging section, the image sensor and the original moves to each position which is based on the respective focus positions acquired in advance.

In accordance with the image reading device of the sixth aspect, the control section of any of the first through fifth aspects acquires in advance a focus position for a time of image reading by the visible light and a focus position for a time of image reading by the infrared light, by controlling the illuminating section and the moving section such that focus control in a case using both the visible light and the infrared light is carried out. The control section controls the moving section such that, at a time of reading the image recorded on the original, at least one of at least one portion of the imaging section, the image sensor and the original is moved to a position which is based on the focus position acquired in advance.

In accordance with the image reading device of the sixth aspect, the same effects as those of any of the first through fifth aspects are achieved. In addition, a focus position for a time of image reading by the visible light and a focus position for a time of image reading by the infrared light are acquired in advance by controlling the illuminating section and the moving section such that focus control in a case using both the visible light and the infrared light is carried out. Control is carried out such that, at a time of reading the image recorded on the original, at least one of at least one portion of the imaging section, the image sensor and the original moves to a position which is based on the focus position acquired in advance. Thus, control is simplified as compared with a case in which focus control is carried out each time an image is read.

In the image reading device of the seventh aspect of the present invention, in any of the first through fifth aspects, the control section acquires in advance a focus position for a time of image reading by one of the visible light and the infrared light, by controlling the illuminating section and the moving section such that focus control in a case using the one of the visible light and the infrared light is carried out, and controls the moving section such that, at a time of reading the image by the one of the visible light and the infrared light, at least one of at least one portion of the imaging section, the image sensor and the original moves to a position which is based on the focus position acquired in advance, and controls the moving section such that, at a time of reading the image by the another of the visible light and the infrared light, at least one of at least one portion of the imaging section, the image sensor and the original moves to a position which is offset, by a predetermined offset amount which is based on a design value of the imaging section, from a position which is based on the focus position acquired in advance.

In accordance with the image reading device of the seventh aspect, the control section of any of the first through fifth aspects acquires in advance a focus position for a time of image reading by one of the visible light and the infrared light, by controlling the illuminating section and the moving section such that focus control in a case using the one of the visible light and the infrared light is carried out. The moving section is controlled such that, at a time of reading the image by the one of the visible light and the infrared light, at least one of at least one portion of the imaging section, the image sensor and the original is moved to a position which is based on the focus position acquired in advance. Further, the moving section is controlled such that, at a time of reading the image by the other of the visible light and the infrared light, at least one of at least one portion of the imaging section, the image sensor and the original is moved to a position which is offset, by a predetermined offset amount which is based on a design value of the imaging section, from a position which is based on the focus position acquired in advance.

In this way, in accordance with the image reading device of the seventh aspect, the same effects as those of any of the first through fifth aspects are achieved. In addition, the control section acquires in advance a focus position for a time of image reading by one of the visible light and the infrared light, by controlling the illuminating section and the moving section such that focus control in a case using the one of the visible light and the infrared light is carried out. Control is effected such that, at a time of reading the image by the one of the visible light and the infrared light, at least one of at least one portion of the imaging section, the image sensor and the original is moved to a position which is based on the focus position acquired in advance. Further, control is effected such that, at a time of reading the image by the other of the visible light and the infrared light, at least one of at least one portion of the imaging section, the image sensor and the original is moved to a position which is offset, by a predetermined offset amount which is based on a design value of the imaging section, from a position which is based on the focus position acquired in advance. Thus, control can be simplified as compared to a case in which focus control is carried out each time an image is read. Further, control can be simplified as compared to a case in which focus control is carried out in advance for both the visible light and the infrared light.

In the image reading device of the eighth aspect of the present invention, in any of the first through the seventh aspects, the at least one portion of the imaging section is, in a case in which the imaging section is formed to include a single focal point lens, the single focal point lens, or is, in a case in which the imaging section is formed to include a zoom lens, at least one portion of the zoom lens.

In the image reading device of the ninth aspect of the present invention, in any of the first through the seventh aspects, the imaging section is provided with a transparent parallel plate which can change the imaging position by the imaging section by being inserted onto and withdrawn from a position on an optical axis of the imaging section, and the moving section inserts the transparent parallel plate onto and withdraws the transparent parallel plate from the position on the optical axis of the imaging section.

In the image reading device of the ninth aspect, a transparent parallel plate, which is provided at the imaging section and which can change the imaging position of the imaging section by being inserted onto and withdrawn from a position on an optical axis of the imaging section, is inserted onto and withdrawn from the position on the optical axis by the moving section. Accordingly, when focus control is carried out at both a time of reading the image by visible light and a time of reading the image by infrared light, the moving section is controlled by the control section of the present invention such that the transparent parallel plate is inserted onto and withdrawn from the position on the optical axis.

In this way, in accordance with the image reading device of the ninth aspect, the same effects as those of any of the first through seventh aspects are obtained. In addition, the imaging section is provided with the transparent parallel plate which can change the imaging position by the imaging section by being inserted onto and withdrawn from a position on the optical axis of the imaging section. The moving section inserts the transparent parallel plate onto and withdraws the transparent parallel plate from the position on the optical axis of the imaging section. Thus, focus control can be carried out without providing an expensive lens such as a single focal point lens or a zoom lens or the like, and the device can be made at a lower cost.

In accordance with a tenth aspect of the present invention, the illuminating section of the present invention one of illuminates the original by selectively emitting the visible light and the infrared light, and illuminates the original by simultaneously emitting the visible light and the infrared light. The aforementioned LED light source is an example of the illuminating section which selectively emits visible light and infrared light. The aforementioned light source which is equipped with a white light source such as a halogen lamp and a filter for color separating the light emitted from the white light source is an example of the illuminating section which simultaneously emits visible light and infrared light.

An image reading device of the eleventh aspect of the present invention comprises: an illuminating section which emits visible light and infrared light and illuminates an original; an imaging section which images one of light transmitted through the original and light reflected by the original, the imaging section being provided with a transparent parallel plate which can change an imaging position by being inserted onto and withdrawn from a position on an optical axis of the imaging section; an image sensor which divides an image imaged by the imaging section into a plurality of pixels and reads the image and outputs the image as image data; a moving section which inserts the transparent parallel plate onto and withdraws the transparent parallel plate from the position on the optical axis of the imaging section; and a control section which, at each of a time of reading the image by the visible light and a time of reading the image by the infrared light, controls the moving section such that focus control is carried out by which the imaging position by the imaging section and a reading position of the image sensor coincide.

In the image reading device of the eleventh aspect, the illuminating section emits the visible light and the infrared light and illuminates an original, one of light transmitted through the original and light reflected by the original is imaged by the imaging section with which the transparent parallel plate which can change the imaging position by being inserted onto and withdrawn from the position on the optical axis of the imaging section, and further, the image sensor divides the image imaged by the imaging section into a plurality of pixels and reads the image and outputs the image as image data. Examples of the original are transmission originals such as photographic films or the like and reflection originals such as photographic prints or the like. The visible light includes red color light, green color light, and blue color light. The illuminating section may be a light source which is equipped with a white light source such as a halogen lamp and a filter for color separating the white light source, or may be an LED light source, or the like.

Further, in the image reading device of the eleventh aspect, at each of the time of reading the image by the visible light and the time of reading the image by the infrared light, the moving section which inserts the transparent parallel plate onto and withdraws the transparent parallel plate from the position on the optical axis of the imaging section is controlled such that focus control is carried out by which the imaging position by the imaging section and the reading position of the image sensor coincide.

In this way, in accordance with the image reading device of the eleventh aspect, at each of a time of reading the image by the visible light and a time of reading the image by the infrared light, control is effected such that focus control is carried out by which an imaging position by the imaging section and a reading position of the image sensor coincide. Thus, by merely controlling an imaging section, a moving section or the like, which are provided in conventional image reading devices, sharp and clear images can be obtained for both image data obtained by image reading by visible light and image data obtained by image reading by infrared light. The structure can be made compact and low cost, and high quality image reading can be carried out by simple control. Further, in the eleventh aspect of the invention, because the imaging section is provided with the transparent parallel plate which can change the imaging position by being inserted onto and withdrawn from the position on the optical axis of the imaging section, and the moving section can insert the transparent parallel plate onto and withdraws the transparent parallel plate from the position on the optical axis of the imaging section, focus control can be carried out without providing an expensive lens such as a single focal point lens or a zoom lens or the like, and the device can be made at a lower cost.

An twelfth aspect of the present invention is an image reading method which illuminates visible light and infrared light onto an original, and reads an image recorded on the original on the basis of one of light transmitted through the original and light reflected by the original, the image reading method comprising the step of: at each of a time of reading the image by the visible light and a time of reading the image by the infrared light, effecting control to move at least one of at least one portion of an imaging section which images one of the light transmitted through the original and the light reflected by the original, an image sensor which divides an image imaged by the imaging section into a plurality of pixels and reads the image and outputs the image as image data, and the original, in an optical axis direction of the imaging section, such that focus control is carried out by which an imaging position by the imaging section and a reading position of the image sensor coincide.

The operation of the image reading method of the twelfth aspect is similar to that of the invention of the first aspect. Thus, in the same way as in the first aspect, by merely controlling an imaging section, a moving section or the like, which are provided in conventional image reading devices, sharp and clear images can be obtained for both image data obtained by image reading by visible light and image data obtained by image reading by infrared light. The structure can be made compact and low cost, and high quality image reading can be carried out by simple control.

In the image reading method of the thirteenth aspect of the present invention, in the twelfth aspect, on the basis of image data obtained by reading the image by the infrared light, a position of at least one of scratch (damage) and foreign matter on the original is detected, and on the basis of results of detection, image data obtained by reading the image by the visible light is corrected.

The operation of the image reading method of the thirteenth aspect is similar to that of the invention of the second aspect. Thus, in the same way as in the second aspect, high quality image data, from which images of damage or foreign matter on the original have been removed, can be obtained.

In the image reading method of the fourteenth aspect of the present invention, in the thirteenth aspect, before correction of the image data obtained by reading the image by the visible light, at least one of magnification chromatic aberration correction and distortion aberration correction is carried out on the image data obtained by reading the image by the infrared light.

The operation of the image reading method of the fourteenth aspect is similar to that of the invention of the third aspect. Thus, in the same way as in the third aspect, regardless of the quality of the optical performance of the imaging section, the accurate position of damage or foreign matter on the original can be detected, and as a result, high quality image data can be obtained.

In the image reading method of the fifteenth aspect of the present invention, in either the fourteenth or thirteenth aspects, before correction of the image data obtained by reading the image by the visible light, an image positional offset amount between the image data obtained by reading the image by infrared light and the image data obtained by reading the image by the visible light, is detected, and, on the basis of the positional offset amount, one of the image data obtained by reading the image by the infrared light or the image data obtained by reading the image by the visible light is corrected such that the positional offset amount becomes minimum.

The operation of the image reading method of the fifteenth aspect is similar to that of the invention of the fourth aspect. Thus, in the same way as in the fourth aspect, the position of damage or foreign matter on the original, which is detected on the basis of the image data obtained by infrared light, can be made to correspond to the position on the image expressed by the image data obtained by visible light. As a result, correction, based on the results of detection of the position of the damage or foreign matter, of the image data obtained by visible light can be carried out accurately.

In the image reading method of the sixteenth aspect of the present invention, in the fifteenth aspect, one of detecting the positional offset amount in advance, and each time the image is read, correcting, on the basis of the positional offset amount, one of the image data obtained by reading the image by the infrared light and the image data obtained by reading the image by the visible light such that the positional offset amount becomes minimum, and each time the image is read, detecting the positional offset amount, and correcting, on the basis of the positional offset amount, one of the image data obtained by reading the image by the infrared light and the image data obtained by reading the image by the visible light such that the positional offset amount becomes minimum, is performed.

In the image reading method of the seventeenth aspect of the present invention, in the twelfth aspect, a focus position for a time of image reading by the visible light and a focus position for a time of image reading by the infrared light are acquired in advance, by controlling illuminating of the visible light and the infrared light and moving of at least one of at least one portion of the imaging section, the image sensor and the original such that focus control in a case using each the visible light and the infrared light is carried out, and at each time reading the image recorded on the original by the respective visible light and infrared light, at least one of at least one portion of the imaging section, the image sensor and the original is controlled to move to each position which is based on the respective focus positions acquired in advance.

In the image reading method of the eighteenth aspect of the present invention, in the twelfth aspect, a focus position for a time of image reading by one of the visible light and the infrared light is acquired in advance, by controlling illuminating of the visible light and the infrared light and moving of at least one of at least one portion of the imaging section, the image sensor and the original such that focus control in a case using the one of the visible light and the infrared light is carried out, and at a time of reading the image by the one of the visible light and the infrared light, at least one of at least one portion of the imaging section, the image sensor and the original is controlled to move to a position which is based on the focus position acquired in advance, and at a time of reading the image by the another of the visible light and the infrared light, at least one of at least one portion of the imaging section, the image sensor and the original is controlled to move to a position which is offset, by a predetermined offset amount which is based on a design value of the imaging section, from the position which is based on the focus position acquired in advance.

In the image reading method of the nineteenth aspect of the present invention, in the twelfth aspect, the at least one portion of the imaging section is, in a case in which the imaging section is formed to include a single focal point lens, the single focal point lens, or is, in a case in which the imaging section is formed to include a zoom lens, at least one portion of the zoom lens.

In the image reading method of the twentieth aspect of the present invention, in the twelfth aspect, the imaging section is provided with a transparent parallel plate which can change the imaging position by the imaging section by being inserted onto and withdrawn from a position on an optical axis of the imaging section, and inserting the transparent parallel plate onto and withdrawing the transparent parallel plate from the position on the optical axis of the imaging section is controlled.

In the image reading method of the twentieth first aspect of the present invention, in the twelfth aspect, the visible light and the infrared light are illuminated to the original by one of selectively emitting and simultaneously emitting.

An image reading method of the twentieth second aspect of the present invention, which illuminates visible light and infrared light onto an original, and reads an image recorded on the original on the basis of one of light transmitted through the original and light reflected by the original, the image reading method comprising the step of: at each of a time of reading the image by the visible light and a time of reading the image by the infrared light, effecting control to move a transparent parallel plate which is provided at an imaging section imaging one of the light transmitted through the original and the light reflected by the original on an image sensor which divides an image imaged by the imaging section into a plurality of pixels and reads the image and outputs the image as image data and which can change an imaging position by being inserted onto and withdrawn from a position on an optical axis of the imaging section, such that focus control is carried out by which the imaging position by the imaging section and a reading position of the image sensor coincide.

### BRIEF DESCRIPTION OF THE DRAWINGS

FIG. 1 is a schematic structural view of a digital lab system relating to embodiments of the present invention.

FIG. 2 is an exterior view of the digital lab system.

FIG. 3 is a schematic structural view of an area CCD scanner section.

FIG. 4 is an exploded perspective view illustrating the detailed structure of a light source section.

FIG. 5 is a block diagram showing the schematic structure of an electrical system of the area CCD scanner section.

FIG. 6 is a flowchart showing a flow of focus position detecting processing relating to a first embodiment.

FIG. 7 is a flowchart showing a flow of focus position searching processing executed while the focus position detecting processing is being executed.

FIG. 8 is a graph explaining focus position searching processing and focus position detecting processing.

FIG. 9A is a flowcharts showing a flow of image reading processing relating to a first embodiment.

FIG. 9B is a flowcharts showing a flow of image reading processing relating to a first embodiment.

FIG. 10 is a flowchart showing a flow of focus position detecting processing relating to a second embodiment.

FIG. 11A is a flowchart showing a flow of image reading processing relating to the second embodiment.

FIG. 11B is a flowchart showing a flow of image reading processing relating to the second embodiment.

FIG. 12A is a flowchart showing a flow of image reading processing relating to a third embodiment.

FIG. 12B is a flowchart showing a flow of image reading processing relating to a third embodiment.

FIG. 13 is a flowchart showing a flow of image positional offset correction processing relating to the third embodiment.

FIG. 14 is a flowchart showing a flow of image positional offset detection processing relating to a fourth embodiment.

FIG. 15A is a flowchart showing a flow of image reading processing relating to the fourth embodiment.

FIG. 15B is a flowchart showing a flow of image reading processing relating to the fourth embodiment.

FIG. 16A is a schematic structural view showing other example of the imaging section and the moving section of the present invention.

FIG. 16B is a schematic structural view showing other example of the imaging section and the moving section of the present invention.

FIG. 16C is a schematic structural view showing other example of the imaging section and the moving section of the present invention.

FIG. 17A is a schematic structural view showing one of various types of examples of the illuminating section of the present invention.

FIG. 17B is a schematic structural view showing one of various types of examples of the illuminating section of the present invention.

FIG. 17C is a schematic structural view showing one of various types of examples of the illuminating section of the present invention.

FIG. 17D is a schematic structural view showing one of various types of examples of the illuminating section of the present invention.

### DESCRIPTION OF THE PREFERRED EMBODIMENTS

Hereinafter, embodiments of the present invention will be described in detail with reference to the drawings. A case will be described hereinafter in which the present invention is applied to a digital lab system.

(First Embodiment)

(Schematic Structure of Entire System)

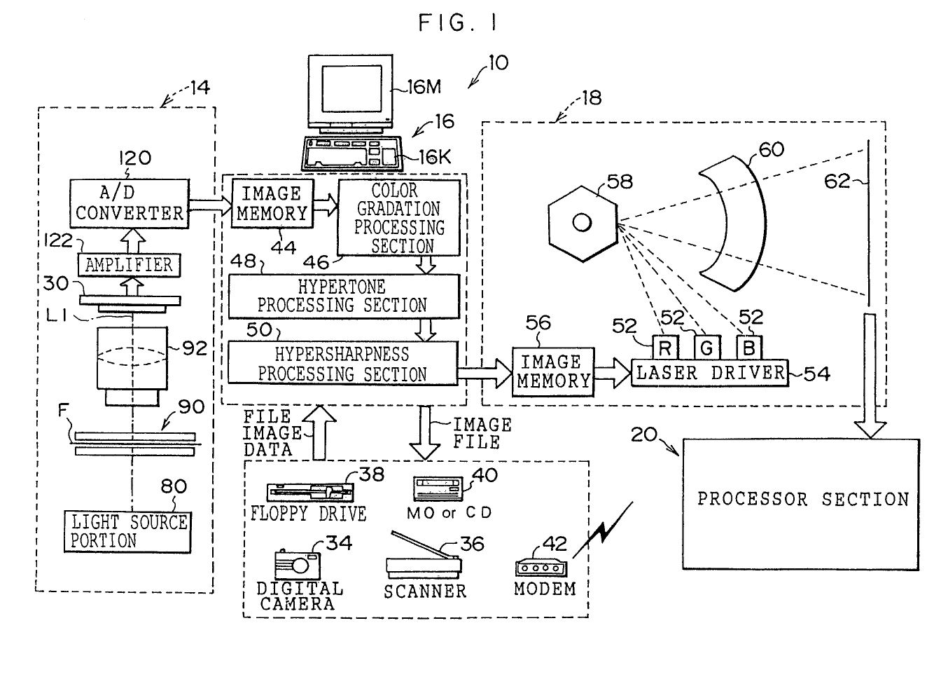

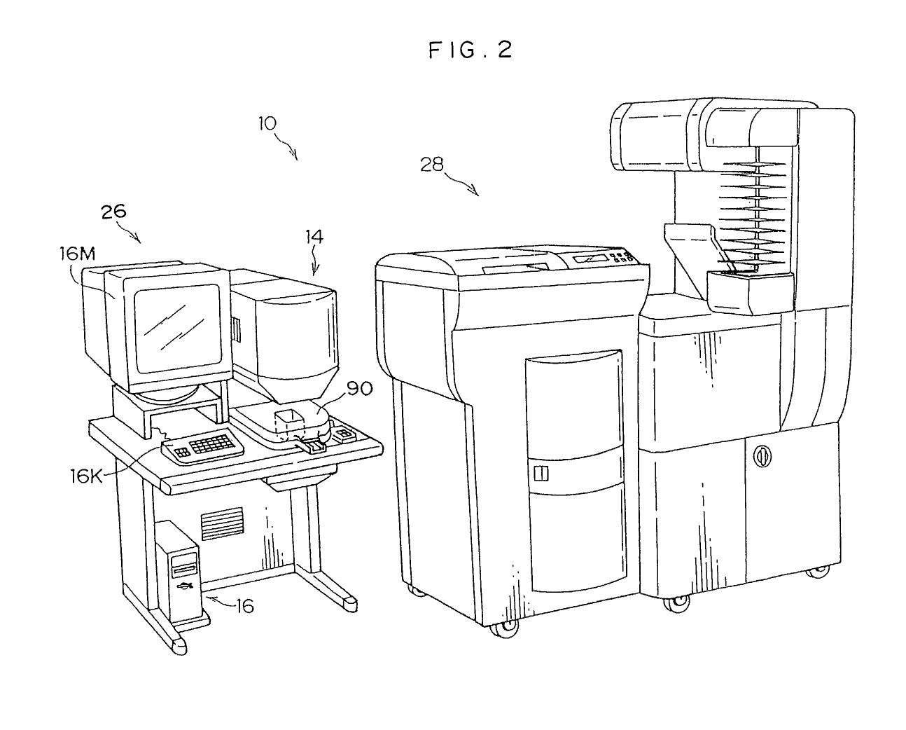

FIGS. 1 and 2 illustrate the schematic structure of a digital lab system 10 relating to the present embodiment.

As illustrated in FIG. 1, the digital lab system 10 includes an area CCD scanner section 14, an image processing section 16, a laser printer section 18, and a processor section 20. The area CCD scanner section 14 and the image processing section 16 are formed integrally as an input section 26 shown in FIG. 2, and the laser printer 18 and the processor section 20 are formed integrally as an output section 28 shown in FIG. 2.

The area CCD scanner section 14 reads frame images recorded on a photographic film such as a negative film or a reversal film or the like. For example, the frame images of a 135 size photographic film, a 110 size photographic film, a photographic film on which a transparent magnetic layer is formed (a 240 size photographic film, known as an APS film), or a 120 size or 220 size (Brownie size) photographic film may be the object of reading. The area CCD scanner section 14 reads the frame images which are the objects of reading by an area CCD 30, amplifies the read data by an amplifier 122, and subjects the amplified data to A/D (analog/digital) conversion at an A/D converter 120. Thereafter, the area CCD scanner section 14 outputs, to the image processing section 16, the image data which has been subjected to processings for correcting portions, in the regions at which the frame images are formed, at which portions the image quality has deteriorated due to damage such as scratches or due to foreign matter such as dust or fingerprints (hereinafter, such processings are referred to as “damage eliminating processing”).

The image data (scan image data) outputted from the area CCD scanner section 14 is inputted to the image processing section 16. Further, image data obtained by photographing by a digital camera 34 or the like, image data obtained by reading an original (e.g., a reflection original or the like) by a scanner 36 (a flat-bed type), image data generated by another computer and recorded on an FD (floppy disk), an MO (magneto-optical disk), a CD (compact disk) or the like and inputted via a floppy disk drive 38, an MO or CD drive 40 or the like, communications image data received via a modem 42, or the like (hereinafter, such data will be collectively referred to as “file image data”) may be inputted to the image processing section 16 from the exterior.

The image processing section 16 stores the inputted image data in an image memory 44, carries out image processings such as various types of correction by a color gradation processing section 46, a hypertone processing section 48, a hypersharpness processing section 50 and the like, and outputs the image processed data as image data for recording to the laser printer section 18. Further, the image processing section 16 may output the image data which has been subjected to image processing to the exterior as an image file (e.g., may output the image data onto a storage medium such as an FD, MO, CD or the like, or may transmit the image data to another information processing device via a communication line).

The laser printer section 18 is equipped with laser light sources 52 of R (red), G (green), and B (blue). The laser printer section 18 controls a laser driver 54 such that laser lights, which are modulated in accordance with the image data for recording which is inputted from the image processing section 16 (and temporarily stored in an image memory 56), are illuminated onto a photographic printing paper 62. An image (latent image) is thus recorded onto the photographic printing paper 62 by scanning exposure (in the present embodiment, by an optical system mainly using a polygon mirror 58 and an fθ lens 60).

At the processor section 20, respective processings of color developing, bleaching fixing, rinsing and drying are carried out on the photographic printing paper 62 on which images have been recorded by scanning exposure at the laser printer section 18. In this way, images are formed on the photographic printing paper 62.

(Structure of Area CCD Scanner Section)

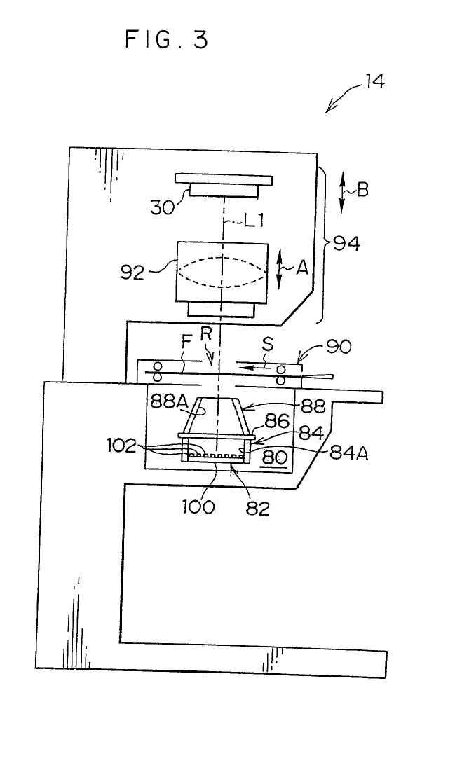

Next, the structure of the area CCD scanner section 14 will be described. The schematic structure of the optical system of the area CCD scanner section 14 is shown in FIG. 3. This optical system is equipped with a light source portion 80 which illuminates light onto a photographic film F. A film carrier 90 is disposed at the light emitting side of the light source portion 80. The film carrier 90 conveys the photographic film F, which is set such that the image surfaces of the frame images are perpendicular to an optical axis (the optical axis of a lens unit which is an imaging optical system and which will be described later) L1, along predetermined directions (the direction of arrow S and the direction opposite thereto).

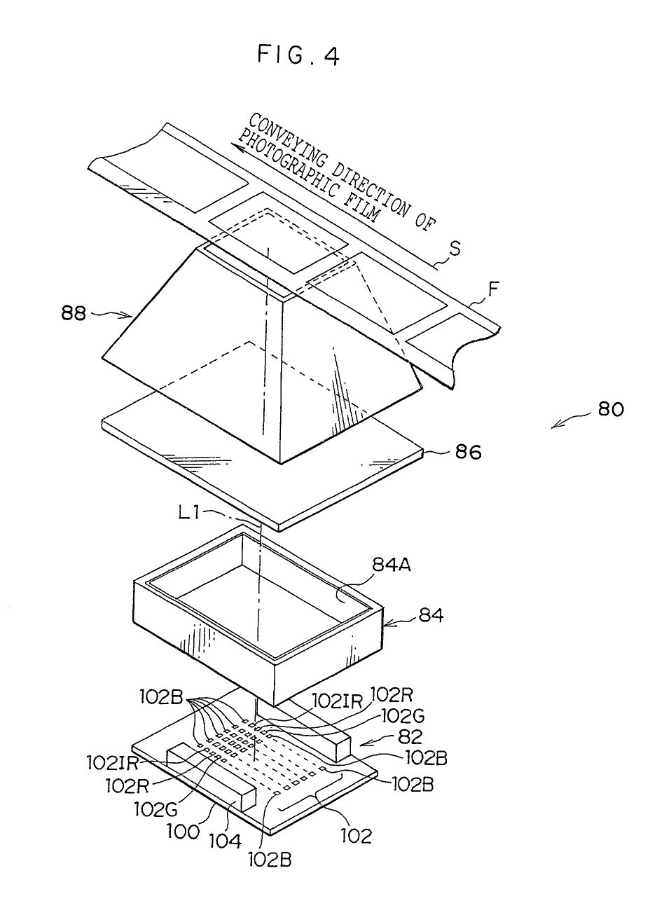

As shown in FIG. 4, an LED light source 82, a diffusion box 84, a transmitting diffusing plate 86, and a waveguide 88 are provided along the optical axis L1 in that order from the bottom in the light source portion 80.

The LED light source 82 is formed by a large number of LED elements 102 being arrayed two-dimensionally on a substrate 100, and is disposed so as to emit light in a direction along the optical axis L1. An aluminum substrate, a glass epoxy substrate, a ceramic substrate, or the like is used as the substrate 100.

At the surface of the substrate 100 at the side at which the LED elements are disposed, terminals of the respective LED elements 102 and terminals of connectors 104 are connected by a wiring pattern (not shown) of a highly electrically conductive material such as copper. In order to prevent corrosion of the wiring pattern due to oxidation or the like, the wiring pattern is covered by a corrosion protection film (hereinafter, “resist film”). The resist film is formed by a highly reflective material which is white or the like. At the LED light source 82, a portion of the light illuminated from each LED element 102 is emitted in a direction along the optical axis L1 as direct light. Another portion of the light is emitted toward the substrate 100, is reflected by the resist film, and is emitted in the direction along the optical axis L1 as reflected light.

The connectors 104 are connected to a control section which governs the operations of the entire area CCD scanner section 14, such that on/off control of the respective LED elements 102 by the control section is possible.

The LED elements 102 relating to the present embodiment are LED elements 102B which emit B (blue) light, LED elements 102IR which emit infrared light, LED elements 102R which emit R (red) light, and LED elements 102G which emit G (green) light, which are arranged in a repeating pattern in order from the downstream side in the direction of arrow S in FIG. 4. On/off control, per color, of the emitted R, G, B and IR lights is possible by the control carried out by the aforementioned control section.

The diffusion box 84 is formed in a sleeve-shaped form whose upper end portion and lower end portion are open, and stands upright at the periphery of the substrate 100 so as to surround the substrate 100. The light emitted from the LED light source 82 enters into the diffusion box 84 without there being a loss in the amount of light.

A reflecting diffusing surface 84A is formed a the inner peripheral surface of the diffusion box 84. The reflecting diffusing surface 84A has high total reflectance and diffusion reflectance of light, and has a substantially uniform spectral reflectance characteristic and spectral diffusion reflectance characteristic.

The reflecting diffusing surface 84A is formed by coating the inner peripheral surface of the diffusion box 84 with a material which has a high reflectance and diffusion reflectance of light and has a substantially uniform spectral reflectance characteristic and spectral diffusion reflectance characteristic, or by forming the inner peripheral surface of the diffusion box 84 by a material which has a high reflectance and diffusion reflectance and has a substantially uniform spectral reflectance characteristic and spectral diffusion reflectance characteristic, or the like.

The diffusion box 84 guides upward the light which is emitted from the LED light source 82, and emits the light toward the transmitting diffusing plate 86. At this time, due to the light being scattered and reflected in random directions by the reflecting diffusing surface 84A, non-uniformity of the light amount of the light from the LED light source 82 can be reduced (the non-uniform light amount distribution can be corrected). Further, at the reflecting diffusing surface 84A, light is diffused and reflected without varying the relative light amount balance between the R light, the G light and the B light emitted from the LED light source 82 (the so-called color balance). Thus, light exits the diffusion box 84 with substantially the same light amount balance as that of the light entering the diffusion box 84 (the light emitted from the LED light source 82).

The transmitting diffusing plate 86 is provided so as to contact the upper end portion of the diffusion box 84, and closes the opening at the upper end portion of the diffusion box 84. The light exiting from the diffusion box 84 is incident on the transmitting diffusing plate 86 without a loss of the amount of light.

The transmitting diffusing plate 86 is formed by, for example, a milky white plate, an opal glass, an LSD (light shaving diffuser) or the like, and is disposed such that the optical central axis thereof coincides with the optical axis L1.

Due to the light exiting from the diffusion box 84 being diffused by and transmitted through the transmitting diffusing plate 86, the light becomes diffused light which spreads in random directions, and the light amount distribution thereof becomes uniform to a certain extent. The transmitting diffusing plate 86 emits light along the optical axis L1 toward the waveguide 88.

The waveguide 88 is formed in a sleeve-shaped form whose upper end portion and lower end portion are open. The lengthwise direction dimension and the widthwise direction dimension of the waveguide 88 become more narrow from the lower end toward the upper end. The opening at the upper end is shaped in a rectangular form which substantially corresponds to a frame image of the photographic film F. The waveguide 88 is disposed such that the optical central axis thereof coincides with the optical axis L1, and such that the lower end portion thereof is closed by the transmitting diffusing plate 86. The light transmitted through the transmitting diffusing plate 86 enters into the waveguide 88 without a loss in the amount of light.

A reflecting surface 88A, which has high reflectance of light, is formed at the inner peripheral surface of the waveguide 88. The light, which has passed through the transmitting diffusing plate 86 and has entered into the waveguide 88, is guided to a vicinity of a film carrier 90, and exits, as light (illumination light) corresponding to the frame image which is the object of reading, toward the photographic film F supported at a reading position R within the film carrier 90.

At the film carrier 90, a predetermined image (hereinafter “chart”) is provided at a position which is in the vicinity of the conveying path of the photographic film F and at which reading by the area CCD 30 which will be described later is possible and which is substantially the same position as the optical axis L1 direction position of the photographic film F supported at the reading position R. The focus control (autofocus control) in the case in which the film carrier 90 is used is carried out by using this chart as the subject (the object to be imaged).

At the area CCD scanner section 14 relating to the present embodiment, at the time that reading of the frame images is carried out, a preliminary reading (hereinafter, “prescanning”), in which the frame images are read at a relatively high speed and low precision, is carried out by using the film carrier 90. On the basis of the image data obtained by the prescanning are determined reading conditions for the time of the main reading (hereinafter, “fine scanning”), in which the frame images are read at a relatively low speed and high precision, and processing conditions of various types of image processings for the image data obtained by fine scanning. Fine scanning is carried out under the determined reading conditions, and image processings in accordance with the determined processing conditions are carried out on the image data obtained by the fine scanning.

Accordingly, the film carrier 90 is structured so as to be able to convey the photographic film F during prescanning and fine scanning at a plurality of speeds which correspond to the densities and the like of the frame images which are to be fine scanned.

Openings, which correspond to the frame image which is set at the reading position R, are provided in the upper surface and the lower surface of the film carrier 90 in order for the light from the light source portion 80 to pass through. The light emitted from the light source portion 80 (specifically, from the diffusion box 84), passes through the opening formed in the lower surface of the film carrier 90 and is illuminated onto the photographic film F. Light of a light amount corresponding to the density of the frame image supported at the reading position R passes through the photographic film F. The light which passes through the photographic film F exits through the opening formed in the upper surface of the film carrier 90.

A lens unit 92, which images the light which has passed through the frame image, and the area CCD sensor 30 are disposed in that order along the optical axis L1 at the side of the photographic film F opposite the side at which the light source portion 80 is disposed. Note that although only a single lens is illustrated as the lens unit 92, the lens unit 92 may actually be a zoom lens formed from a plurality of lenses. Further, a SELFOC lens may be used as the lens unit 92. In this case, it is preferable that both end surfaces of the SELFOC lens are set as close as possible to the photographic film F and the area CCD 30.

The lens unit 92 is supported so as to be slidable in the directions of arrow A so as to approach and move away from the film carrier 90 in order to change the magnification, such as effect reduction or enlargement or the like. A reading section 94, which is formed by the lens unit 92 and the area CCD 30, is supported so as to be slidable in the directions of arrow B so as to approach and move away from the film carrier 90 in order to ensure the conjugate length at the time of focus control or the aforementioned changing of the magnification.

A sensing portion is provided at the light incident side of the area CCD 30. At the sensing portion, a plurality of CCD cells are arrayed two-dimensionally, and an electronic shutter mechanism is provided. Further, although not shown, a shutter is provided between the area CCD 30 and the lens unit 92.

The area CCD 30 detects density information of the frame image positioned at the reading position R of the film carrier 90, and outputs the density information as an image signal to the A/D converter 120 (see FIG. 1) via the amplifier 122. The A/D converter 120 digitally converts the image signal from the area CCD 30. After damage eliminating processing is carried out on the digital signal, the area CCD scanner section 14 transmits the processed signal to the image processing section 16 as image data.

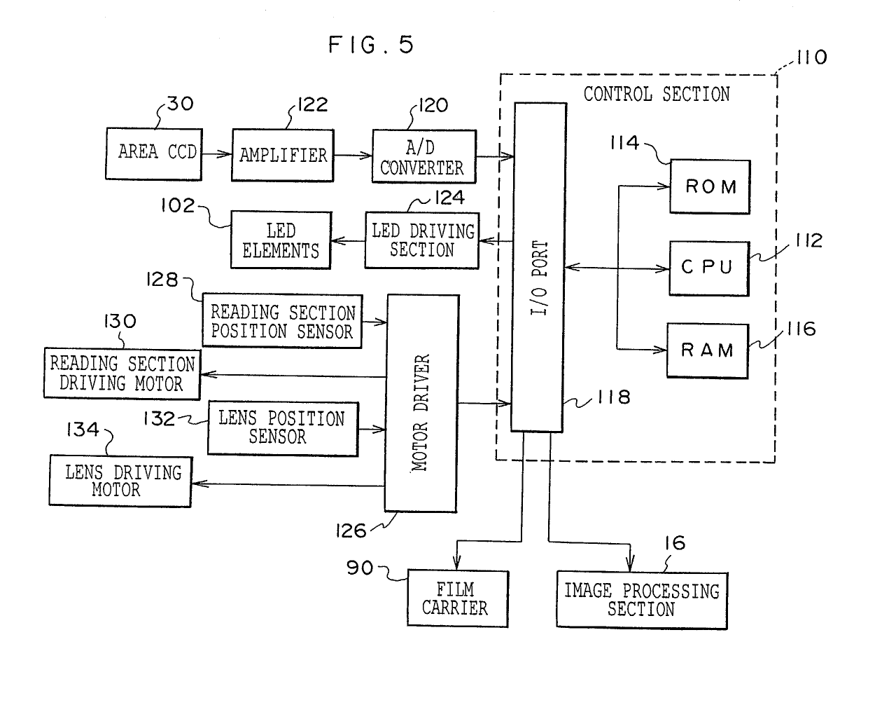

Next, the schematic structure of the electrical system of the area CCD scanner section 14 will be described with reference to FIG. 5. As shown in FIG. 5, the area CCD scanner section 14 relating to the present embodiment is provided with a control section 110 which governs the operations of the entire area CCD scanner section 14.

The control section 110 is provided with a CPU (central processing unit) 112; a ROM 114 in which are stored various programs executed by the CPU 112 and various parameters and the like; a RAM 116 used as a work area or the like at the time that the various programs are executed by the CPU 112; and an I/O port 118 which carries out input and output of various signals between the control section 110 and the exterior. The CPU 112, the ROM 114, the RAM 116 and the I/O port 118 are connected together by a bus.

The area CCD 30 is connected to the I/O port 118 via the A/D converter 120 and the amplifier 122 in that order. The image signal, which is the analog signal outputted from the area CCD 30, is amplified by the amplifier 122 and converted into digital data by the A/D converter 120, and thereafter, inputted to the CPU 112 via the I/O port 118.

The large number of LED elements 102 provided at the LED light source 82 are connected to the I/O port 118 via an LED driving section 124. The CPU 112 can control the driving of the LED elements 102 by the LED driving section 124.

Connected to the I/O port 118 via a motor driver 126 are a reading section position sensor 128 which detects the position of the reading section 94 (i.e., the area CCD 30 and the lens unit 92); a reading section driving motor 130 which slides the reading section 94 along the directions of arrow B in FIG. 3; a lens position sensor 132 which detects the position of the lens unit 92; and a lens driving motor 134 which slides the lens unit 92 along the directions of arrow A in FIG. 3.

The CPU 112 determines the optical magnification in accordance with the size of the frame image which is the object of reading and whether or not trimming is to be carried out and the like. The CPU 112 slides the reading section 94 by the reading section driving motor 130 on the basis of the position of the reading section 94 detected by the reading section position sensor 128, such that the frame image is read by the area CCD 30 at the determined optical magnification. Further, the CPU 112 slides the lens unit 92 by the lens driving motor 134 on the basis of the position of the lens unit 92 detected by the lens position sensor 132.

In a case in which focus control is carried out in order to make the light receiving surface of the area CCD 30 coincide with the frame image imaging position by the lens unit 92, the CPU 112 slides only the reading section 94 by the reading section driving motor 130.

Namely, the imaging relationship at the area CCD scanner section 14 of the present embodiment is determined by the relative positions, in the direction of the optical axis L1, of the area CCD 30, the lens unit 92, and the photographic film F which is positioned on the optical axis L1. In the present embodiment, as described above, when the optical magnification is to be set, the reading section 94 is slid by the reading section driving motor 130 and the lens unit 92 is slid by the lens driving motor 134. In order to maintain this imaging relationship in the state in which the optical magnification is set in this way, focus control is carried out by changing the distance between the lens unit 92 and the photographic film F while the distance between the area CCD 30 and the lens unit 92 remains fixed.

By carrying out focus control in this way, variations in the optical magnification of respective frame images when a plurality of frame images recorded on a photographic film F are continuously read, can be suppressed.

In the present embodiment, the focus control is carried out by a TTL (through the lens) system such that contrast of the image read by the area CCD 30 is a maximum.

The film carrier 90 and the image processing section 16 are connected to the I/O port 118. The driving of the film carrier 90 is controlled by the CPU 112. The image data, which has been subjected to various processings such as damage eliminating processing and the like by the CPU 112, is outputted to the image processing section 16.

The area CCD scanner section 14 corresponds to the image reading device of the present invention. The area CCD 30 corresponds to the image sensor of the present invention. The light source portion 80 corresponds to the illuminating section of the present invention. The lens unit 92 corresponds to the imaging section of the present invention. The control section 110 corresponds to the control section of the present invention. The reading section driving motor 130 and the lens driving motor 134 correspond to the moving section of the present invention. The photographic film F corresponds to the original of the present invention.

(Operation)

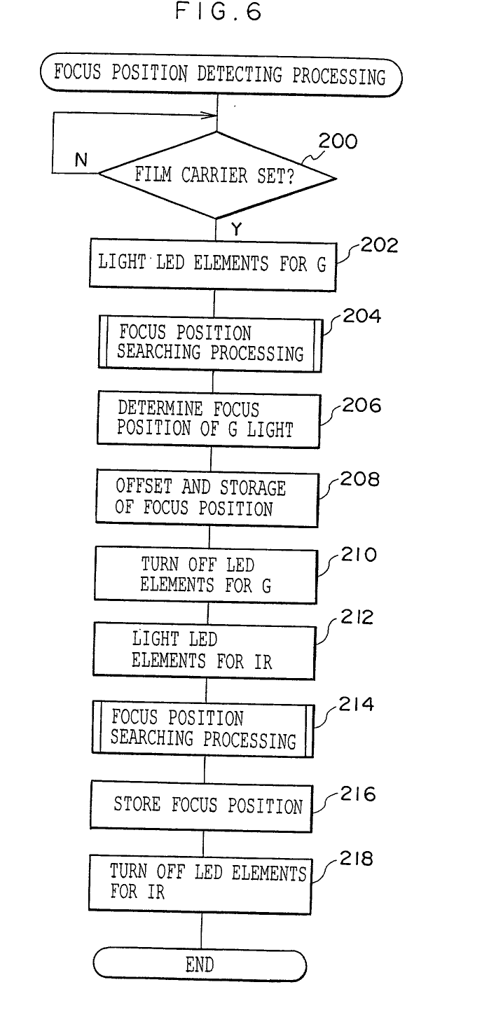

Next, operation of the digital lab system 10 which is structured as described above will be explained. At the area CCD scanner section 14 of the digital lab system 10 relating to the present embodiment, when the power is turned on (namely, at the time of start-up of the area CCD scanner section 14), focus position detecting processing is carried out by the control section 110. Here, first, the focus position detecting processing carried out by the control section 110 will be described with reference to FIG. 6. FIG. 6 is a flowchart showing the flow of the focus position detecting processing program executed by the CPU 112 at the time that focus position detecting processing is carried out by the control section 110. This program is stored in advance in the ROM 114.

First, in step 200, the routine waits for the setting of the film carrier 90 at a predetermined position of the area CCD scanner section 14. In the subsequent step 202, the LED driving section 124 is controlled such that, among the LED elements 102 provided at the LED light source 82, only the LED elements 102G which emit green color light are lit.

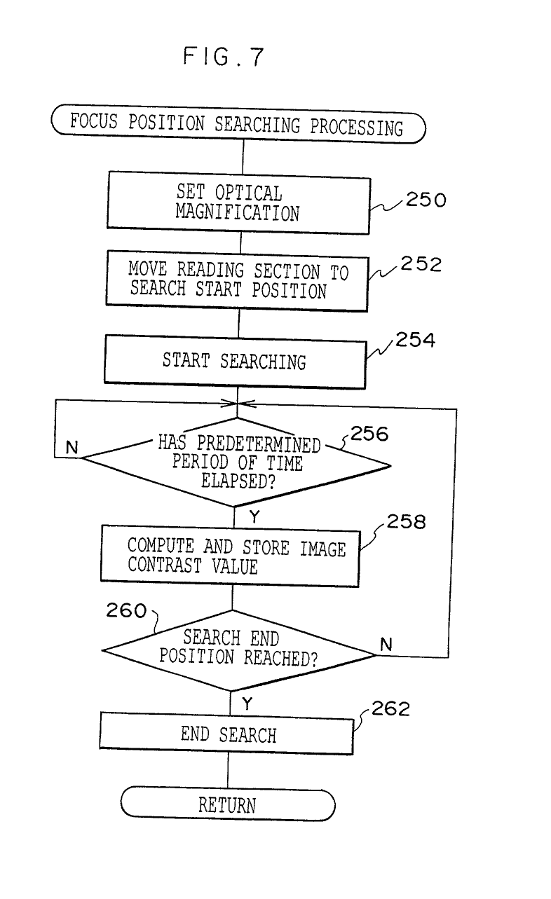

In subsequent step 204, focus position searching processing is carried out. This focus position searching processing will be described next with reference to FIG. 7.

In step 250, the reading section 94 and the lens unit 92 are slid by the reading section driving motor 130 and the lens driving motor 134 such that the optical magnification by the lens unit 92 becomes a predetermined optical magnification (1.0 times in the present embodiment).

In the following step 252, the position of the reading section 94 is slid, by the reading section driving motor 130, to a search start position at a focus position search region (search area) of the chart (not shown) provided at the film carrier 90. The search area of the focus position of the chart is determined in advance by experimentation for each type of optical magnification, and is stored in the ROM 114. The CPU 112 reads out the search area for the current optical magnification (=1.0 times) from the ROM 114, and slides the reading section 94 to the search start position by sliding the reading section 94 such that, for example, the focal length is the shortest focal length in the search area. In this case, the search end position is the position at which the focal length is longest in the search area.

In subsequent step 254, the search operation is started by starting the sliding of the reading section 94 by the reading section driving motor 130 at a predetermined speed and toward the search end position. In step 256, the routine waits until a predetermined period of time has elapsed. This predetermined period of time is a time obtained by dividing, by a plural number (6 in the present embodiment), the time over which the reading section 94 is slid at the aforementioned predetermined speed from the search start position to the search end position.

When the predetermined time has elapsed, the determination in step 256 is affirmative, and the routine moves on to step 258 where the image contrast value of the chart read by the area CCD 30 at this point in time is computed and stored in a predetermined region of the RAM 116. The image contrast value in the present embodiment is an integral value of an MTF (modulation transfer function) of a predetermined spatial frequency region in the read image.

In following step 260, on the basis of the position information of the reading section 94 obtained by the reading section position sensor 128, a determination is made as to whether the reading section 94 has reached the search end position. If the reading section 94 has not reached the search end position, the routine returns to step 256, and the processings of steps 256 through 260 are repeated until the search end position is reached. By repeating these processings, image contrast values of a number which is equal to the number of plural positions in the search area (6 positions in the present embodiment) are computed and are stored in the RAM 116.

When the reading section 94 reaches the search end position, the determination of step 260 is affirmative, and the routine moves on to step 262 where, by stopping the sliding movement of the reading section 94, the search operation is finished and the present focus position search routine is completed.

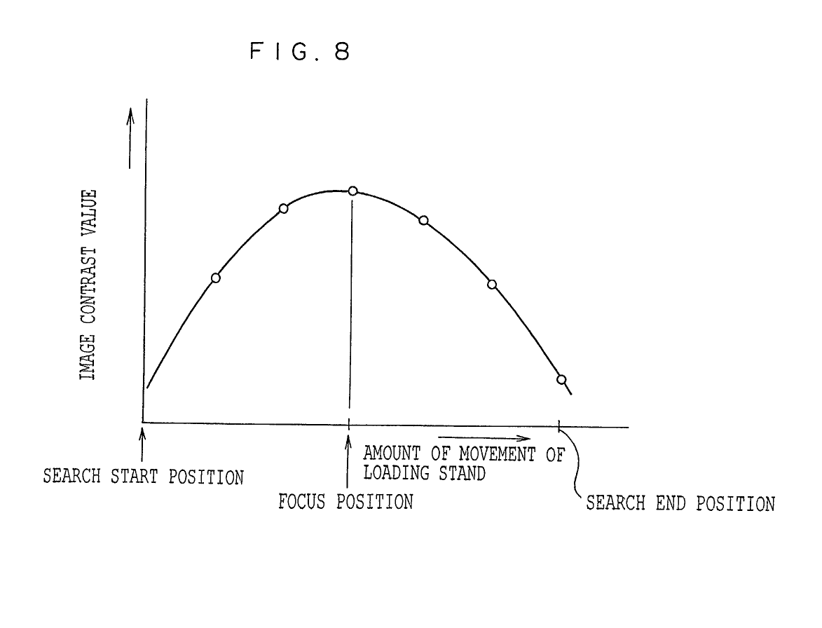

By repeating the processings of steps 256 through 260 of the present focus position search routine, as shown in FIG. 8, image contrast values at six positions from the search start position to the search end position are obtained.

When the focus position search processing is completed, the routine moves on to step 206 of FIG. 6 where, among the six positions in the search area whose image contrast values have been stored in the RAM 116 by the above-described focus position searching processing, the position whose image contrast value is greatest is determined to be the focus position at the time of image reading by the G light (see FIG. 8). In a case in which the reading section driving motor 130 is a pulse motor, this focus position can be expressed by the number of driving pulses of the reading section driving motor 130 (hereinafter “focus number of pulses”) for movement from the mechanical origin of the reading section 94 (hereinafter, “origin H.P. ”). Hereinafter, a case will be described in which the respective positions of the reading section 94, such as the focus position and the like, are expressed by numbers of driving pulses.

In the following step 208, after a predetermined offset value is added to the value expressing the aforementioned focus position of the G light, this sum is stored in a predetermined region of the RAM 116 as the average focus position at the time of image reading by visible light. The offset value is obtained in advance by experimentation as a value which, by being added to the value which expresses the focus position of the G light, can express the average position of the focus positions at the time of image reading for each of the colors of the three visible lights (R light, G light, B light), and the offset value is stored in the ROM 114. Accordingly, the focus position stored in the RAM 116 in present step 208 is used in common as the focus position at the time of image reading by the aforementioned three visible lights.

In subsequent step 210, the LED driving section 124 is controlled such that the LED elements 102G are turned off. In next step 212, the LED driving section 124 is controlled so that only the LED elements 102IR which emit infrared light are lit. In the next step 214, the focus position searching processing shown in FIG. 7 is again carried out. In this focus position searching processing, in accordance with the above-described processing, image contrast values of six positions (see FIG. 8) from the search start position to the search end position of the aforementioned unillustrated chart are obtained for a case in which the optical magnification is 1.0 and infrared light is used as the light which carries the image of the chart.

When the focus position searching processing for the case in which infrared light is used is completed, the routine moves on to step 216 where, among the six positions in the search area whose image contrast values have been stored in the RAM 116 by the above-described focus position searching processing, the position at which the image contrast value is the greatest is determined as the focus position at the time of image reading, and is stored in a predetermined region of the RAM 116. In next step 218, the LED driver section 124 is controlled such that the LED elements 102IR are turned off, and thereafter, the present focus position detecting processing ends.

A focus position, which can be used in common at the time of image reading by the respective visible lights, and a focus position, which canbe used at the time of image reading by infrared light, are obtained by this focus position detecting processing, and are stored in a predetermined region of the RAM 116. In the present focus position detecting processing, the reason why the LED elements 102G which emit G light are used at the time of determining the focus position of the visible lights is that the peak of the luminosity characteristic is positioned in the G wavelength region.

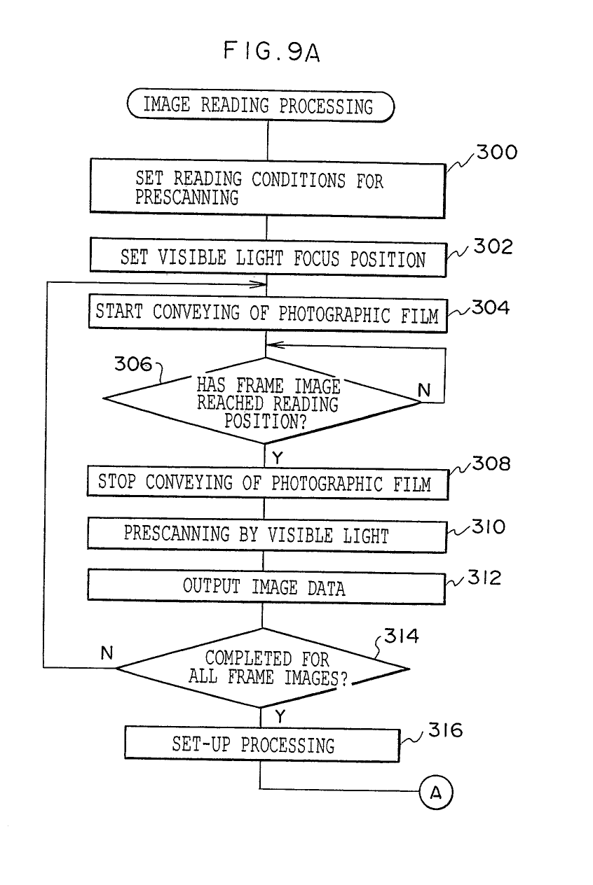

Next, image reading processing of the area CCD scanner section 14 will be described with reference to the flowchart of FIG. 9. FIG. 9 is a flowchart showing the flow of an image reading processing program which is executed by the CPU 112 of the control section 110 at the time when image reading processing is carried out by the area CCD scanner section 14. This program is stored in advance in the ROM 114. At the area CCD scanner section 14, a “prescan mode” and a “fine scan mode” are set in advance as the modes for the time of reading the photographic film. The state of each portion of the area CCD scanner section 14 in each mode is determined in advance. Further, in the present embodiment, a case will be described in which the photographic film F which is the object of reading is a single 135 size negative film.

In step 300 of FIG. 9, the routine enters the “prescan mode”, and the operations of the respective portions are controlled in accordance with the states of the respective portions determined in advance as the “prescan mode”, such that prescanning of the photographic film F is carried out under predetermined reading conditions.

Namely, the reading section 94 and the lens unit 92 are slid by the reading section driving motor 130 and the lens driving motor 134 such that the optical magnification by the lens unit 92 is 1.0 times. Further, t, which is the smallest value, is set as the operation time of the electronic shutter of the area CCD 30 (the reading cycle by the area CCD 30 (the charge accumulating time)). Accordingly, prescanning of the photographic film F is carried out at a relatively rough resolution and high speed, and the processing is completed in a short period of time.

In the next step 302, the average focus position at the time of image reading by visible light, which was stored in the predetermined region of the RAM 116 in step 208 of the previously-described focus position detecting processing, is read, and the reading section 94 is slid by the reading section driving motor 130 on the basis of the position of the reading section 94 detected by the reading section position sensor 128, such that the reading section 94 is positioned at the position expressed by the focus position. In this way, the reading section 94 is positioned at the common focus position for the three visible lights (R light, G light, B light).

In subsequent step 304, the film carrier 90 starts conveying of the photographic film F due to an instruction to convey the photographic film F in a predetermined direction (the direction of arrow S in FIG. 3). In following step 306, the routine waits until the reading position R of the frame image of the photographic film F is reached. In the subsequent step 308, by instructing the film carrier 90 to stop conveying of the photographic film F, the conveying of the photographic film F is stopped.

In following step 310, prescanning, by the three visible lights, of the frame image positioned at the reading position R is carried out.

Specifically, among the LED elements 102 provided at the LED light source 82, the R image data is acquired in a state in which only the LED elements 102R which emit R light are lit, and then, the G image data is acquired in a state in which only the LED elements 102G which emit G light are lit. Thereafter, the B image data is acquired in a state in which only the LED elements 102B which emit blue light are lit. In this way, prescanning of the frame image under the reading conditions of the prescan mode set in step 300 is carried out.

In next step 312, the image data obtained by prescanning in step 310 is outputted as prescan image data to the image processing section 16. In next step 314, a determination is made as to whether the image reading (prescanning) by above-described steps 304 through 312 has been carried out for all of the frame images. If prescanning is not completed (i.e., if the answer to the determination is negative), the routine returns to step 304. When prescanning is completed (i.e., when the answer to the determination is affirmative), the routine moves on to step 316. During the prescanning, at the image processing section 16, the prescan image data inputted from the area CCD scanner section 14 is successively stored in a storage portion (not shown).

In step 316, a predetermined image characteristic amount of the frame image is computed from the prescan image data stored in the aforementioned unillustrated storage portion by the image processing section 16 at the time of prescanning.

Further, in step 316, on the basis of the computed image characteristic amount, the type of density of the frame image and the processing conditions for the image processing of the fine scan image data are set by computation.

The type of density of the frame image can be classified into low density/normal density/high density/ultra-high density, by comparing, for example, the average density, the maximum density, the minimum density, or the like, with a predetermined value. Further, processing conditions for image processings such as hypertone and hypersharpness and the like (specifically, the degree of compression of gradation with respect to the ultra-low frequency luminance components of the image, the gain (degree of enhancement) with respect to the high frequency components and medium frequency components of the image), and the like are computed as the processing conditions for image processings.

When setting of the density types and image processing conditions for all of the frame images as described above has been completed, in the next step 318, the film carrier 90 is instructed to reverse the conveying direction of the photographic film F, and in the subsequent step 320, the film carrier 90 is instructed to convey the photographic film F. In this way, movement of the photographic film F in the direction opposite to the direction of arrow S in FIG. 3 is started.

In the following step 322, the routine waits for the frame image of the photographic film F to arrive at the reading position R. In next step 324, by instructing the film carrier 90 to stop conveying of the photographic film F, conveying of the photographic film F is stopped.

In subsequent step 326, the average focus position for the time of image reading by the visible lights, which was stored in a predetermined region of the RAM 116, is read out, and the reading section 94 is slid by the reading section driving motor 130 on the basis of the position of the reading section 94 detected by the reading section position sensor 128, such that the reading section 94 is positioned at the position expressed by the focus position. In this way, the reading section 94 is positioned at the focus position which is common to the three visible lights (R light, G light, B light).

In next step 328, fine scanning, by the three visible lights, of the frame image positioned at the reading position R is carried out.

Specifically, first, the operations of the respective portions of the area CCD scanner section 14 are controlled such that fine scanning of the frame image can be carried out under reading conditions which are appropriate for the type of density of the frame image. Namely, first, setting of a fine scan mode which corresponds to the type of the density of the frame image is carried out. Next, reading by the area CCD 30 of the frame image positioned at the reading position R is carried out. In the present embodiment, among the LED elements 102 provided at the LED light source 82, the R image data is acquired in a state in which only the LED elements 102R which emit R light are lit, and then the G image data is acquired in a state in which only the LED elements 102G which emit G light are lit, and thereafter, the B image data is acquired in a state in which only the LED elements 102B which emit B light are lit. In this way, fine scanning of the frame image under reading conditions which are optimal for the type of density of the frame image is carried out.

In next step 330, the focus position at the time of image reading by infrared light, which was stored in the predetermined region of the RAM 116 in step 216 in the previously-described focus position detecting processing, is read out. The reading section 94 is slid by the reading section driving motor 130 on the basis of the position of the reading section 94 detected by the reading section position sensor 128, such that the reading section 94 is positioned at the position expressed by the focus position. In this way, the reading section 94 is positioned at a focus position which is optimal for image reading by infrared light.

In following step 332, fine scanning, by infrared light, of the frame image positioned at the reading position R is carried out. In this case, image data is acquired in a state in which, among the LED elements 102 provided at the LED light source 82, only the LED elements 102IR which emit infrared light are lit.

In the next step 334, magnification chromatic aberration correction and distortion aberration correction are carried out on the image data acquired by the infrared light in step 332.

In the magnification chromatic aberration correction in the present embodiment, at each position on the frame image, magnification chromatic aberration correction data is measured and stored in advance. This magnification chromatic aberration correction data expresses the direction of color offset and the amount of color offset of a non-reference color (e.g., R, B) with respect to a reference color (e.g., G) which color offset is caused by magnification chromatic aberration of the lens unit 92. For the image data which is the object of processing, for each non-reference color, positions of pixels expressed by image data in the case in which there is no magnification chromatic aberration, are determined on the basis of the magnification chromatic aberration correction data stored in advance. Density values of the non-reference colors at the original positions (the same positions as the position of the pixel of the reference color) are determined by interpolation computation.

In the distortion aberration correction in the present embodiment, distortion aberration correction data are measured and stored in advance. The distortion aberration correction data represent the direction of movement and the amount of movement of the position of each pixel which movement is caused by distortion aberration of the lens unit 92, with the original positions of the respective pixels forming the frame image being a reference. For the image data which is the object of processing, positions of pixels expressed by image data in the case in which there is no distortion aberration, are determined on the basis of the distortion aberration correction data stored in advance. Density values at the original positions are determined by interpolation computation.

In next step 336, on the basis of the image data obtained by the infrared light which has been subjected to aberration correction by above-described step 334, damage eliminating processing is carried out on the image data obtained by the visible light in step 328. In the damage eliminating processing of the present embodiment, on the basis of the aberration-corrected image data obtained by the infrared light, the positions of damage, such as scratches, and foreign matter, such as fingerprints and dust, are detected. Density values of the pixels in the image data obtained by the visible light, which correspond to the detected positions, are obtained by interpolation computation using the density values of the surrounding pixels.

In next step 338, the image data, which was subjected to damage eliminating processing in above-described step 336, is outputted to the image processing section 16 as fine scan image data.

The fine scan image data, which is outputted to the image processing section 16 from the area CCD scanner section 14, is subjected to image processing at the image processing section 16 under the processing conditions which were stored previously, and the processed data is outputted to the laser printer section 18 and printing is carried out.

In subsequent step 340, a determination is made as to whether image reading (fine scanning) by above-described steps 320 through 338 has been completed for all of the frame images. If fine scanning has not been completed (i.e., if the answer to the determination is negative), the routine returns to step 320. When fine scanning is completed (i.e., when the answer to the determination is affirmative), the present image reading processing is completed.

As described above in detail, in the area CCD scanner section which serves as the image reading device of the present first embodiment, control is carried out such that focus control is carried out both at the time of image reading by visible light and at the time of image reading by infrared light. Thus, by only controlling the lens unit and the like which are provided at a conventional image reading device, sharp and clear images can be obtained for both image data obtained by image reading by visible light and image data obtained by image reading by infrared light. A structure which is low cost and requires little space can be realized, and high quality image reading can be carried out by control which is easy.

Further in the area CCD scanner section relating to the present first embodiment, on the basis of the image data obtained by reading of the image by infrared light, the position of a scratch or foreign matter on the photographic film is detected, and based on the results of detection, the image data obtained by reading the image by visible light is corrected (damage eliminating processing). Thus, high quality image data, from which images of scratches or foreign matter on the photographic film have been eliminated, can be obtained.

Further, in the area CCD scanner section relating to the present first embodiment, before the damage eliminating processing, the magnification chromatic aberration correction and distortion aberration correction are both carried out on the image data obtained by reading the image by infrared light. Thus, regardless of the quality of the optical performance of the lens unit, the correct positions of scratches and foreign matter on the photographic film can be detected, and as a result, high quality image data can be obtained.

Further, in the area CCD scanner section relating to the present first embodiment, the focus position at the time of reading the image by visible light and the focus position at the time of reading the image by infrared light are acquired in advance by effecting control such that focus control is carried out in cases in which visible light and infrared light are respectively used. Control is carried out such that the reading section moves to a position based on the focus position acquired in advance at the time the image recorded on the photographic film is read. Thus, as compared with a case in which focus control is carried out each time an image is read, control can be simplified.

(Second Embodiment)

In the above-described first embodiment, a case is described in which the focus position for the time of image reading by infrared light is obtained in advance, and the reading section 94 is positioned at that focus position at the time that the image is read by infrared light. However, in the present second embodiment, a case is described in which, without the focus position for the time of image reading by infrared light being obtained in advance, the reading section 94 is positioned at the focus position at the time of image reading by infrared light. Note that the structure of the digital lab system relating to the present second embodiment is the same as that of the digital lab system 10 relating to the first embodiment, and description thereof will be omitted.

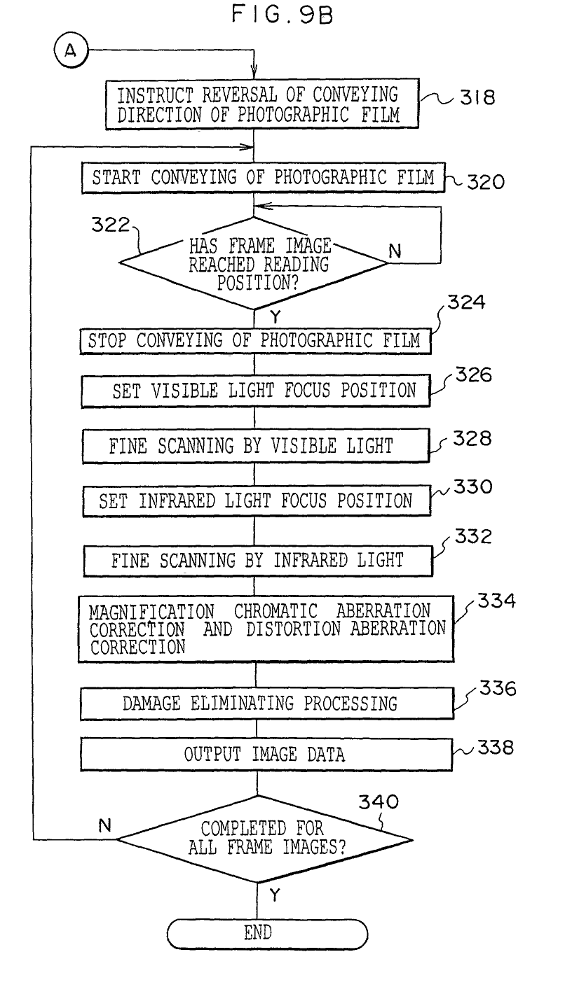

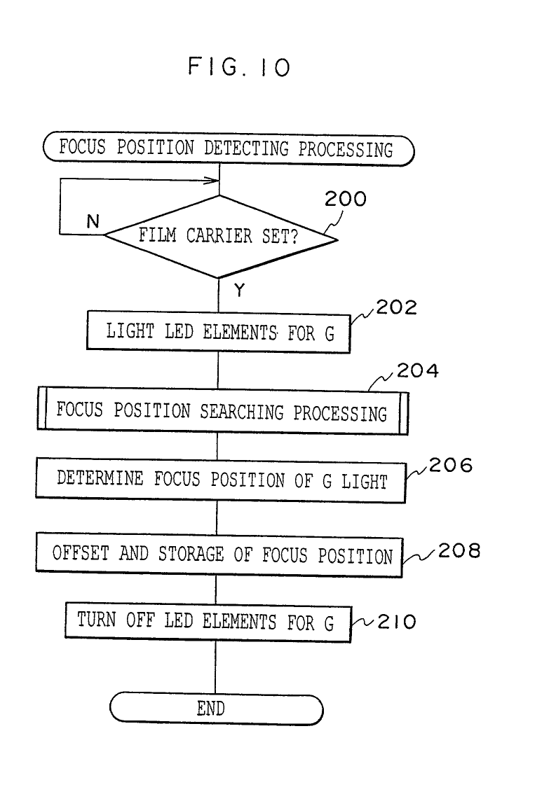

First, with reference to FIG. 10, the focus position detecting processing executed at a control section 110 relating to the second embodiment will be described. Steps in FIG. 10 which carry out the same processings as in FIG. 6 are denoted by the same step numbers as in FIG. 6.

As shown in FIG. 10, the focus position detecting processing of the present second embodiment differs from the first embodiment only with respect to the point that processings from step 212 on, i.e., the acquiring of the focus position for the time of image reading by infrared light, are not carried out. Accordingly, in the focus position detecting processing of the present second embodiment, only the focus position for the time of image reading by visible light is acquired.

Next, the image reading processing of the area CCD scanner section 14 relating to the present second embodiment will be described with reference to the flowchart of FIG. 11. Steps in FIG. 11 which carry out the same processings as in FIG. 9 are denoted by the same step numbers as in FIG. 9.

As shown in FIG. 11, the image reading processing of the present second embodiment differs from the first embodiment only with respect to the point that the processing of step 330 is replaced by the processing of step 330′ in which the focus position for infrared light is set by sliding the reading section 94 by the reading section driving motor 130 in a predetermined direction by a predetermined amount of shifting. The predetermined amount of shifting in the present second embodiment is a value by which the reading section 94 is positioned at the focus position for the time of image reading by infrared light, by the reading section 94, which is positioned at the focus position for the time of image reading by visible light, being slid in the predetermined direction by the predetermined amount of shifting. A value which is obtained on the basis of a set value of the lens unit 92 is used as the predetermined amount of shifting.

As described above in detail, with the area CCD scanner section serving as the image reading device of the present second embodiment, not only the same effects as those of the first embodiment can be achieved, but also, the following effect is achieved. By effecting control such that focus control is carried out in the case in which visible light is used, the focus position for the time of image reading by visible light is acquired in advance. Control is carried out such that, at the time of reading the image by visible light, the reading section moves to aposition based on the focus position acquired in advance. Control is carried out such that, at the time of reading the image by infrared light, the reading section moves to a position which is shifted by a predetermined amount of shifting, which is based on a set value of the lens unit, with respect to a position based on the focus position acquired in advance. Thus, as compared with a case in which focus control is carried out each time an image is read, control is simplified. Further, as compared with a case in which focus control is carried out in advance for both visible light and infrared light, control is simplified.

(Third Embodiment)

In the present third embodiment, an example is described of a case in which, before damage eliminating processing is carried out, an image positional offset amount between image data obtained by reading the image by infrared light and image data obtained by reading the image by visible light is detected, and, on the basis of the positional offset amount, the image data obtained by reading the image by infrared light or the image data obtained by reading the image by visible light is corrected such that the positional offset amount becomes minimum. Note that the structure of the digital lab system relating to the present third embodiment is the same as that of the digital lab system 10 relating to the previously-described first embodiment, and thus, description thereof will be omitted.

Hereinafter, operation of the digital lab system 10 relating to the present third embodiment will be explained. In the digital lab system 10 relating to the third embodiment, focus position detecting processing (see FIG. 6) is carried out in the same way as in the first embodiment.

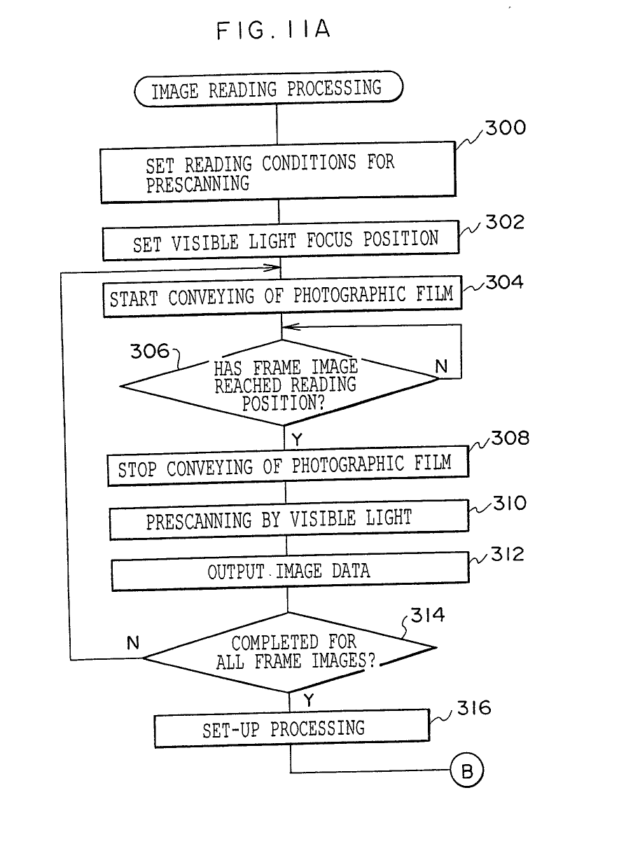

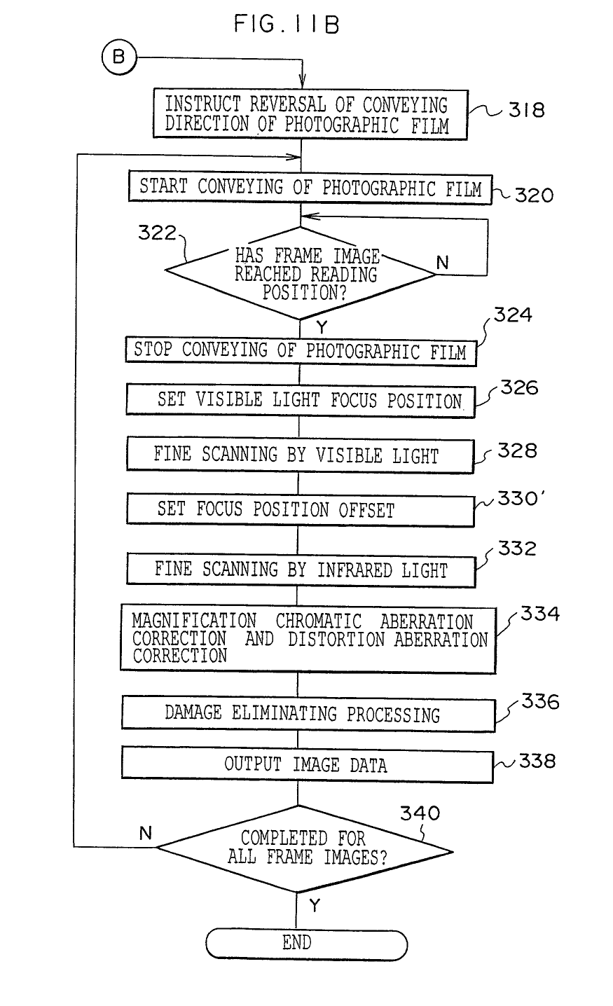

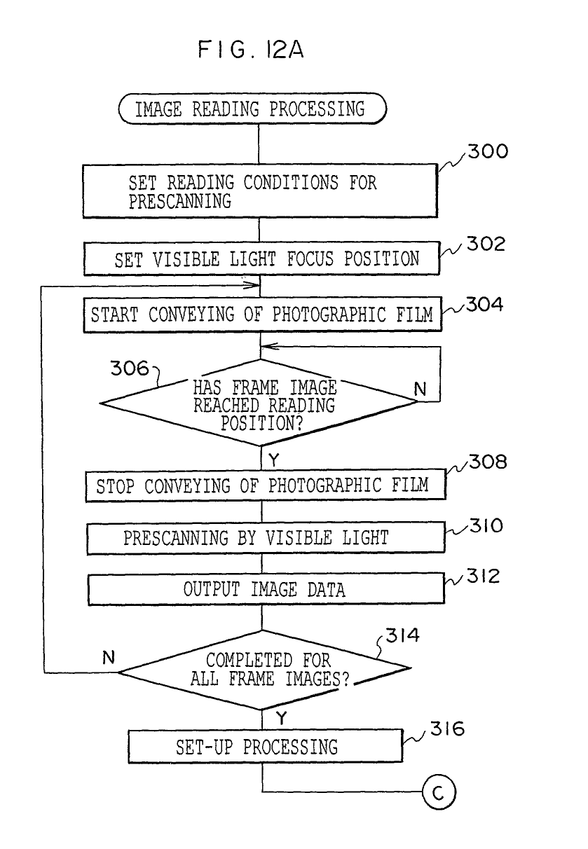

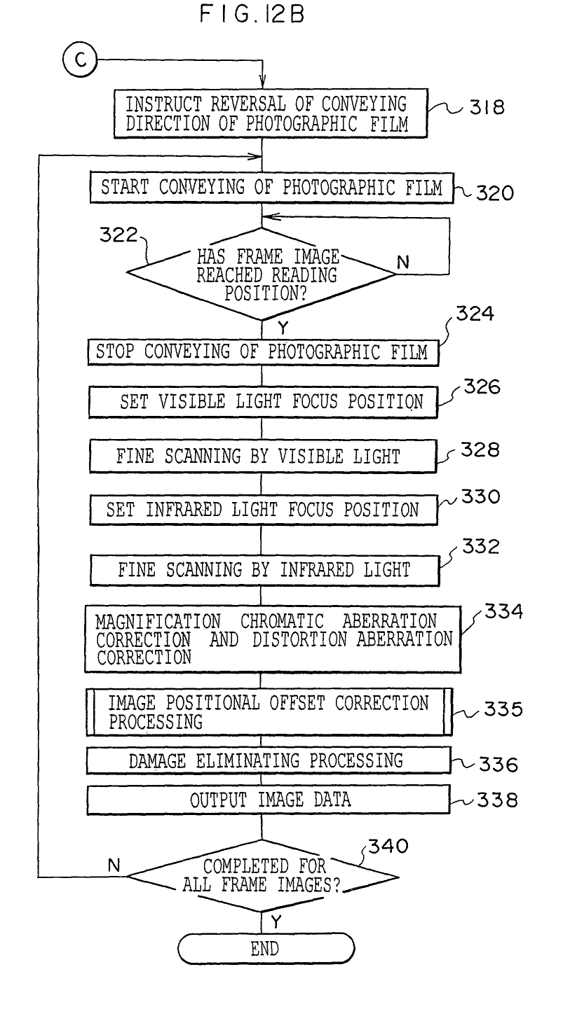

Next, image reading processing of the area CCD scanner section 14 relating to the present third embodiment will be described with reference to the flowchart of FIG. 12. Processings in FIG. 12 which are the same as those of FIG. 9 are denoted by the same step numbers as in FIG. 9, and description of these steps will be omitted.

As shown in FIG. 12, the image reading processing of the present third embodiment differs from the first embodiment only with respect to the point that, between the aberration correction processing of step 334 and the damage eliminating processing of step 336, image positional offset correction processing is carried out as step 335.

Hereinafter, the image positional offset correction processing relating to the present embodiment will be described with reference to FIG. 13. FIG. 13 is a flowchart showing the flow of an image positional offset correction processing program executed by the CPU 112 of the control section 110 when image positional offset correction processing is carried out by the area CCD scanner section 14. This program is stored in advance in the ROM 114.

In step 400 of FIG. 13, on the basis of the image data obtained by infrared light which has undergone the aberration correction of step 334, one region of a predetermined size, at which damage such as a scratch has arisen or to which foreign matter such as a fingerprint or dust has adhered (hereinafter, such a region is referred to as a “damaged region”), is detected. In subsequent step 402, image data corresponding to the detected damaged region (hereinafter, “damaged region image data”) is extracted from the image data obtained by infrared light.

In next step 404, by using the damaged region image data extracted in step 402 as a template, template matching for the image data of any of the visible lights obtained by fine scanning in step 328 (G in the present embodiment) is carried out as follows.

The aforementioned template is raster scanned while being moved, pixel by pixel, on the image expressed by the G image data. Each time, the remainder R between the template and the G image data is computed by following formula (1):

$$R = {\sum }_{j = 1}^{M} {\sum }_{i = 1}^{N} \vert I ( i , j ) - T ( i , j ) \vert \qquad ( 1 )$$

wherein M is the number of pixels in the line direction of the template, N is the number of pixels in the row direction of the template, I(i,j) is the G image data, and T(i,j) is the template.

Because such template matching is a conventional method which is widely carried out, detailed description thereof will be omitted.

In subsequent step 406, the image region of the image expressed by the G image data located at the raster scan position corresponding to the remainder R having the smallest value among the plurality of remainders R obtained by the above-described template matching, is detected as an image region (damaged image region) corresponding to the image expressed by the template (damaged region image data).

The image region of the image expressed by the G image data detected by the above-described processings is an image region which is positioned at the same position as damage or foreign matter included in the damaged region image data extracted from the image data obtained by infrared light in previous step 402.

In next step 408, the difference between the position in the image data obtained by infrared light of the damaged region image data extracted in step 402, and the position in the G image data of the image region detected in step 406 is computed. (This difference corresponds to the “positional offset amount” of the present invention.) On the basis of this difference, the image data obtained by infrared light is corrected such that the difference becomes minimum, and thereafter, the present image positional offset correction processing is completed.

Due to the image positional offset correction processing, the positional offset between the image represented by the image data obtained by infrared light and the image represented by the image data obtained by visible light, can be corrected.

As described in detail above, in the area CCD scanner section which serves as the image reading device relating to the present third embodiment, the same effects as those of the first embodiment are obtained. In addition, before damage eliminating processing is carried out, an image positional offset amount between image data obtained by reading the image by infrared light and image data obtained by reading the image by visible light is detected, and, on the basis of this positional offset amount, the image data obtained by reading the image by infrared light is corrected such that the positional offset amount becomes minimum. Thus, the position of damage or foreign matter on the photographic film, which is detected on the basis of the image data obtained by infrared light, can be made to correspond to the position on the image expressed by the image data obtained by visible light. As a result, damage eliminating processing of the image data obtained by visible light can be carried out accurately.

Further, in the area CCD scanner section relating to the present third embodiment, each time an image is read, the positional offset amount is detected, and on the basis of the positional offset amount, the image data obtained by reading the image by infrared light is corrected such that the positional offset amount becomes minimum. Thus, damage eliminating processing of the image data obtained by visible light can be carried out with high accuracy even in a system in which, each time an image is read, there is a dispersion in the positional offsets expressed by the positional offset amounts.

(Fourth Embodiment)

In the above-described third embodiment, an example is described of a case in which an image positional offset amount between image data obtained by reading the image by visible light and image data obtained by reading the image by infrared light is detected each time image reading is carried out, and, on the basis of the positional offset amount, the image data obtained by reading the image by infrared light is corrected such that the positional offset amount becomes minimum. However, in the present fourth embodiment, an example is described of a case in which the aforementioned positional offset amount is detected in advance, and each time an image is read, the image data obtained by reading the image by infrared light is corrected, on the basis of the positional offset amount, such that the positional offset amount becomes minimum. Note that the structure of the digital lab system relating to the present fourth embodiment is the same as that of the digital lab system 10 relating to the previously-described first embodiment, and thus, description thereof will be omitted.

Hereinafter, operation of the digital lab system 10 relating to the present fourth embodiment will be explained. In the digital lab system 10 relating to the fourth embodiment, at the time the power is turned on, focus position detecting processing (see FIG. 6) is carried out in the same way as in the first embodiment.

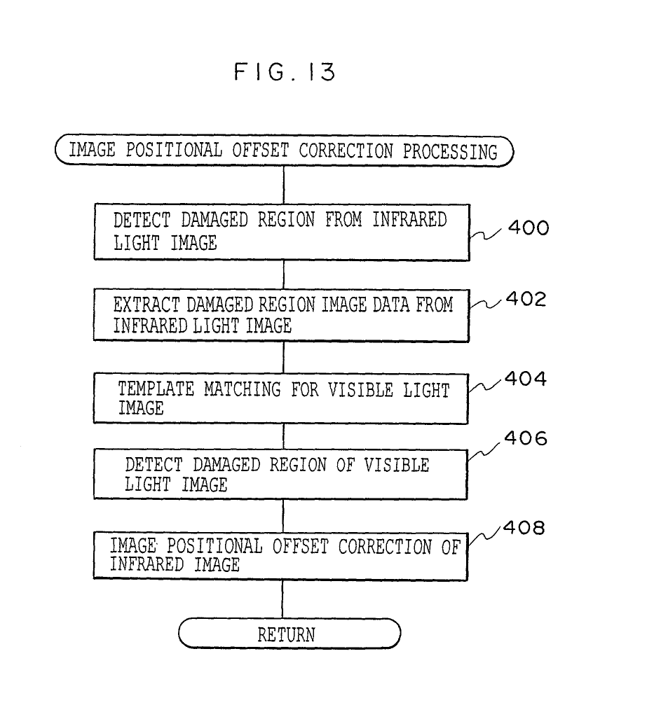

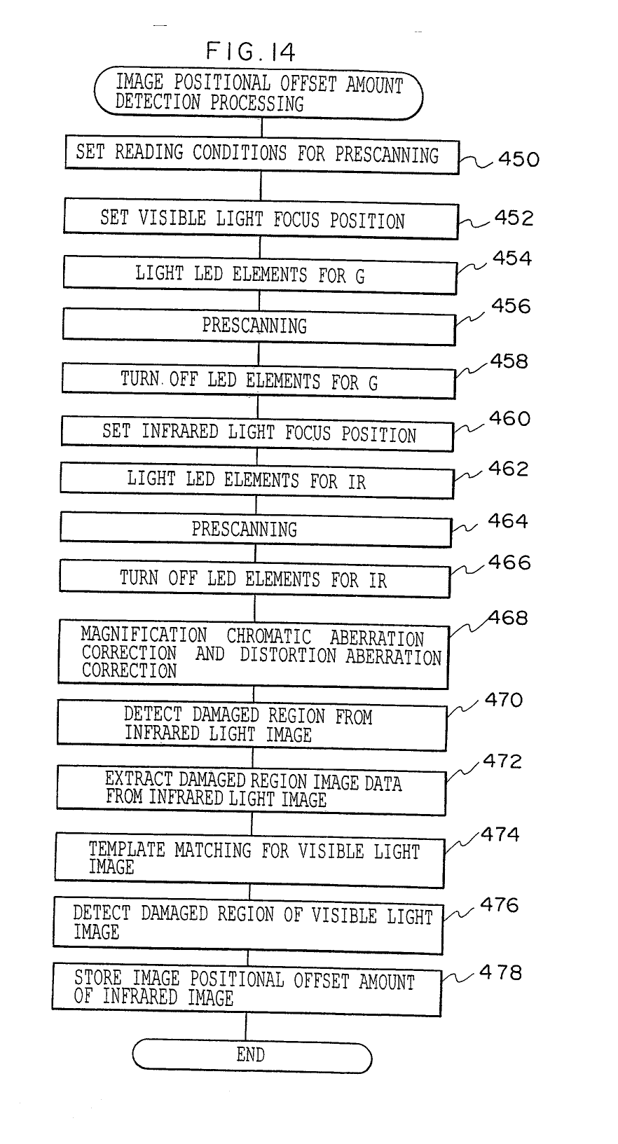

In the digital lab system 10 relating to the present fourth embodiment, the image positional offset amount detecting processing is carried out when the focus position detecting processing is completed. Next, this image positional offset amount detecting processing will be described with reference to the flowchart of FIG. 14. FIG. 14 is a flowchart showing the flow of an image positional offset amount detecting processing program which is executed by the CPU 112 of the control section 110 at the time when the image positional offset amount detecting processing is carried out by the area CCD scanner section 14. This program is stored in advance in the ROM 114. Here, explanation will be given presupposing that the film carrier 90 has been loaded into a predetermined position of the area CCD scanner section 14 and that a predetermined photographic film is set at the film carrier 90 in a state in which a frame image, which has intentionally been damaged, is positioned at the reading position R.

In step 450 of FIG. 14, the routine enters the “prescan mode”, and the operations of the respective portions are controlled in accordance with the states of the respective portions determined in advance as the “prescan mode”, such that prescanning of the photographic film is carried out under predetermined reading conditions.

Namely, the reading section 94 and the lens unit 92 are slid by the reading section driving motor 130 and the lens driving motor 134 such that the optical magnification by the lens unit 92 is 1.0 times. Further, t, which is the smallest value, is set as the operation time of the electronic shutter of the area CCD 30.

In the next step 452, the average focus position at the time of image reading by visible light, which was stored in the predetermined region of the RAM 116 in step 208 of the previously-described focus position detecting processing, is read, and the reading section 94 is slid by the reading section driving motor 130 on the basis of the position of the reading section 94 detected by the reading section position sensor 128, such that the reading section 94 is positioned at the position expressed by the focus position. In this way, the reading section 94 is positioned at the common focus position for the three visible lights (R light, G light, B light).

In subsequent step 454, the LED driving section 124 is controlled such that, among the LED elements 102 provided at the LED light source 82, only the LED elements 102G which emit G light are lit. In next step 456, prescanning, by which image data of the frame image positioned at the reading position R is acquired, is carried out.

In next step 458, the LED driving section 124 is controlled such that the LED elements 102G are turned off. In following step 460, the focus position for the time of image reading by infrared light, which was stored in the predetermined region of the RAM 116 in step 216 of the previously-described focus position detecting processing, is read, and the reading section 94 is slid by the reading section driving motor 130 on the basis of the position of the reading section 94 detected by the reading section position sensor 128, such that the reading section 94 is positioned at the position expressed by the focus position. In this way, the reading section 94 is positioned at the focus position which is suited for image reading by infrared light.

In next step 462, the LED driving section 124 is controlled such that, among the LED elements 102 provided at the LED light source 82, only the LED elements 102IR which emit infrared light are lit. In the following step 464, prescanning, by which the image data of the frame image positioned at the reading position R is acquired, is carried out. In the next step 466, the LED driving section 124 is controlled such that the LED elements 102IR are turned off.

In following step 468, in the same way as the processing of step 334 in the previously-described image reading processing, magnification chromatic aberration correction and distortion aberration correction are carried out on the image data obtained by infrared light which was acquired in step 464.

In the next step 470, on the basis of the image data obtained by infrared light which was subjected to aberration correction in step 468, the damaged region of a predetermined size, at which exists the damage which was intentionally caused in advance, is detected. In following step 472, damaged region image data corresponding to the detected damaged region is extracted from the image data obtained by infrared light.

In subsequent step 474, by using the damaged region image data extracted in step 472 as a template, in the same way as in step 404 of the previously-described image positional offset correction processing (see FIG. 13 as well), template matching is carried out on the G image data acquired by prescanning in step 456.

In step 476, the image region of the image expressed by the G image data located at the raster scan position corresponding to the remainder R having the smallest value among the plurality of remainders R obtained by the above-described template matching is detected as an image region (damaged image region) corresponding to the image expressed by the template (damaged region image data).

The image region of the image expressed by the G image data detected by the above-described processings is an image region which is positioned at the same position as the damage included in the damaged region image data extracted from the image data obtained by infrared light in previous step 472.

In next step 478, the difference between the position in the image data obtained by infrared light of the damaged region image data extracted in step 472, and the position in the G image data of the image region detected in step 476 is computed. (This difference corresponds to the “positional offset amount” of the present invention.) After the data expressing this difference is stored in a predetermined region of the RAM 116, the present image positional offset amount detecting processing is completed.

Next, image readingprocessing of the area CCD scanner section 14 relating to the present fourth embodiment will be described with reference to the flowchart of FIG. 15. Processings in FIG. 15 which are the same as those of FIG. 9 are denoted by the same step numbers are in FIG. 9, and description of these steps will be omitted.

As shown in FIG. 15, the image reading processing of the present fourth embodiment differs from the first embodiment only with respect to the point that, between the aberration correction processing of step 334 and the damage eliminating processing of step 336, image positional offset correction is carried out as step 335′ on the image data obtained by infrared light.

Namely, in step 335′ of the image reading processing of the present fourth embodiment, the data, which expresses the difference which was stored in the predetermined region of the RAM 116 in step 478 of the previously-described image positional offset amount detecting processing (see FIG. 14 as well), is read, and on the basis of the difference expressed by this data, the image data obtained by the infrared light is corrected such that this difference becomes minimum.

As described above in detail, in the area CCD scanner section serving as the image reading device relating to the present fourth embodiment, the same effects as those of the first embodiment can be obtained. In addition, before damage eliminating processing is carried out, an image positional offset amount between image data obtained by reading the image by infrared light and image data obtained by reading the image by visible light is detected, and, on the basis of the positional offset amount, the image data obtained by reading the image by infrared light is corrected such that the positional offset amount becomes minimum. Thus, the position of damage or foreign matter on the photographic film, which is detected on the basis of the image data obtained by infrared light, can be made to correspond to the position on the image expressed by the image data obtained by visible light. As a result, damage eliminating processing of the image data obtained by visible light can be carried out accurately.

Further, in the area CCD scanner section relating to the present fourth embodiment, the positional offset amount is detected in advance, and each time image reading is carried out, the image data obtained by reading the image by infrared light is corrected, on the basis of the positional offset amount, such that the positional offset amount becomes minimum. Thus, as compared with a case in which the positional offset amount is detected each time an image is read, processing can be made faster.

In the above-described third and fourth embodiments, as shown by step 408 in FIG. 13 and step 335, in FIG. 15, cases are described in which image positional offset correction is carried out on the image data obtained by infrared light. However, the present invention is not limited to the same, and image positional offset correction can be carried out on the image data obtained by visible light. In this case, image positional offset correction can be carried out on all of the R, G, B image data. In this case as well, the same effects as those of the third and fourth embodiments are achieved.

Moreover, the third and fourth embodiments describe cases in which, at the time that template matching is carried out, the difference R between the template and the G (visible light) image data is computed by above formula (1). However, the present invention is not limited to the same. It is possible to compute the cross-correlation coefficient C expressed by following formula (2), or another value which expresses the distance between the template and the G (visible light) image data.

$$C = \frac{{\sum }_{j = 1}^{M} {\sum }_{i = 1}^{N} φ ( i , j ) ϕ ( i , j )}{\sqrt{{\sum }_{j = 1}^{M} {\sum }_{i = 1}^{N} {φ ( i , j )}^{2} {\sum }_{j = 1}^{M} {\sum }_{i = 1}^{N} {φ ( i , j )}^{2}}} \qquad ( 2 )$$

wherein

$$φ ( i , j ) = I ( i , j ) - ( {\sum }_{j = 1}^{M} {\sum }_{i = 1}^{N} I ( i , j ) / NM , ϕ ( i , j ) = T ( i , j ) - ( {\sum }_{j = 1}^{M} {\sum }_{i = 1}^{N} T ( i , j ) ) / NM$$

In the case in which the cross-correlation coefficient C is computed, the greater the value of the cross-correlation coefficient C, the greater the correlation with the image. Thus, the image region of the image expressed by the G image data positioned at the raster scan position corresponding to the cross-correlation coefficient C having the greatest value, can be detected as the image region (damaged region) corresponding to the image expressed by the template (damaged region image data). In this case as well, the same effects as those of the third and fourth embodiments can be obtained.

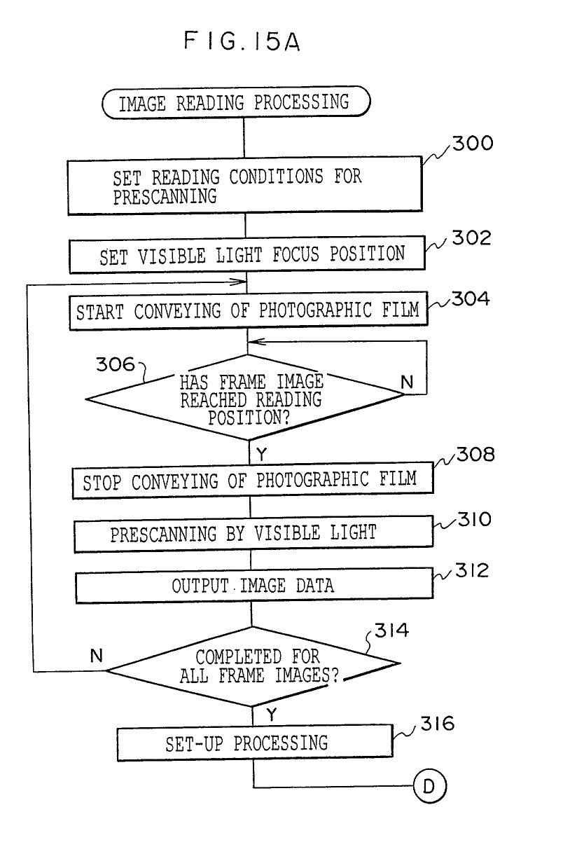

Further, in each of the above-described embodiments, cases are described in which the lens unit 92 is used as the imaging section of the present invention, and focus control is carried out by changing the distance between the lens unit 92 and the photographic film F while the distance between the area CCD 30 and the lens unit 92 remains fixed. However, the present invention is not limited to the same, and any of the various examples shown in FIG. 16 can be applied.

Namely, the example in FIG. 16A is an example in which a single focal point lens 92A is used as the imaging section of the present invention, and focus control is carried out by moving the area CCD 30 along the optical axis direction (the directions of arrow C in FIG. 16A) in a state in which the distance between the single focal point lens 92A and the photographic film F is fixed.

Further, the example in FIG. 16B is an example in which a zoom lens 92B is used as the imaging section of the present invention, and focus control is carried out by moving a portion of the zoom lens 92B along the optical axis direction of the zoom lens 92B (the directions of arrow D in FIG. 16B).

Moreover, the example in FIG. 16C is an example in which the imaging section of the present invention is the single focal point lens 92A and a transparent parallel plate 72 which can change the imaging position by the single focal point lens 92A by being inserted into and withdrawn from a position on the optical axis of the single focal point lens 92A. The moving section of the present invention is a transparent parallel plate driving motor 72A which can insert the transparent parallel plate 72 onto and withdraw the transparent parallel plate 72 from the position on the optical axis by moving the transparent parallel plate 72 in the directions of arrow E in FIG. 16C. Focus control is carried out by the transparent parallel plate driving motor 72A inserting the transparent parallel plate 72 onto and withdrawing the transparent parallel plate 72 from the position on the optical axis.

In these cases as well, the same effects as those of the above-described embodiments are obtained.

Further, in each of the above-described embodiments, cases are described in which a focus position, which can be used in common for the three visible lights (R light, G light, B light), is acquired in the focus position detecting processing. However, the present invention is not limited to the same. For example, by carrying out focus position searching processing (see FIG. 7) for each of the three visible lights, a focus position can be acquired for each color, and focus positions can be set for each color at the time of image reading. In this case, although more time is required for focus position detecting processing than in the above-described embodiments, an optimal focus position can be set for each color, and thus, the image data acquired by the image reading processing is high quality.

Further, in each of the above-described embodiments, cases are described in which the damage eliminating processing is carried out by determining, by interpolation computation using density values of surrounding pixels, the density values of pixels which correspond to the position of the scratch or the like obtained on the basis of the image data obtained by infrared light. However, the present invention is not limited to the same. For example, the rate of amplification by the amplifier 122 of the pixels, which correspond to the position of the scratch or the like obtained on the basis of the image data obtained by infrared light, can be increased as compared to other pixels (hereinafter, this method will be referred to as the “gain adjusting method”). In this case, when even a slight amount of the density value of the pixel which is the object of processing is obtained, the value corresponding to that density value is obtained as the density value of the pixel which is the object of processing. Thus, as compared with the damage eliminating processing of the above-described respective embodiments, high quality image data can be obtained. Namely, in the damage eliminating processing of the above-described embodiments, there are cases in which the resolution is lowered and a false contour is generated because the density value is obtained by interpolation computation using density values of the surrounding pixels. However, with the gain adjusting method, the generation of a false contour can be suppressed, and as a result, high quality image data can be obtained.

Further, in the above-described embodiments, cases are described in which the focus position detecting processing is carried out at the time of start-up of the area CCD scanner section 14. However, the present invention is not limited to the same. For example, this processing can be carried out at the time when the film carrier is replaced by another, or at the time when the photographic film which is the object of reading is changed. In such cases as well, the same effects as those of the above-described embodiments are achieved.

Cases are described in the above embodiments in which both magnification chromatic aberration correction and distortion aberration correction are carried out as the aberration correction. However, the present invention is not limited to the same, and, for example, it is possible to carry out only one of magnification chromatic aberration correction and distortion aberration correction. In this case, although the accuracy of detecting the position of a scratch or foreign matter deteriorates, the time required to carry out image reading processing can be shortened.

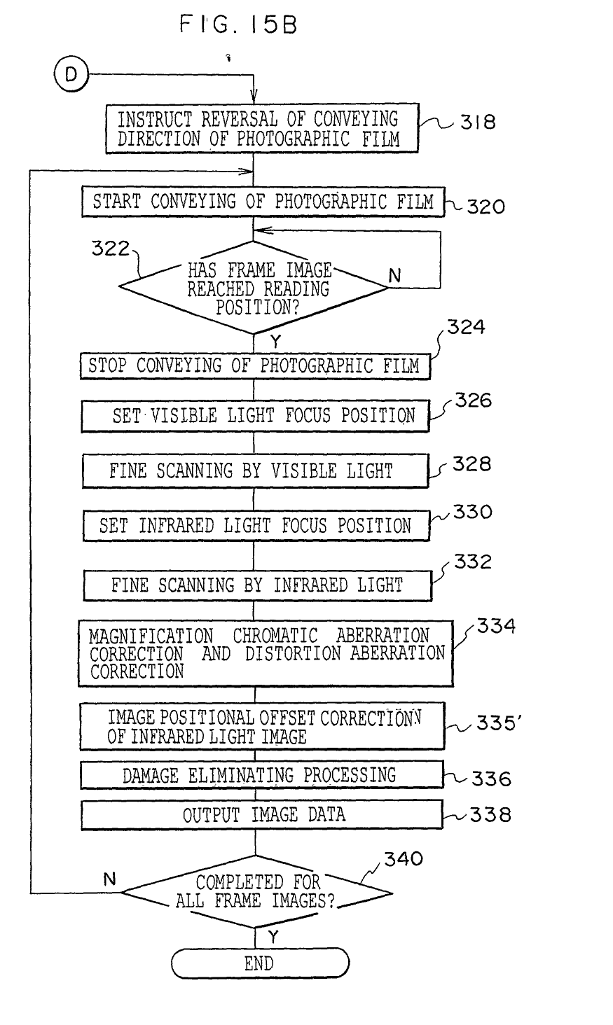

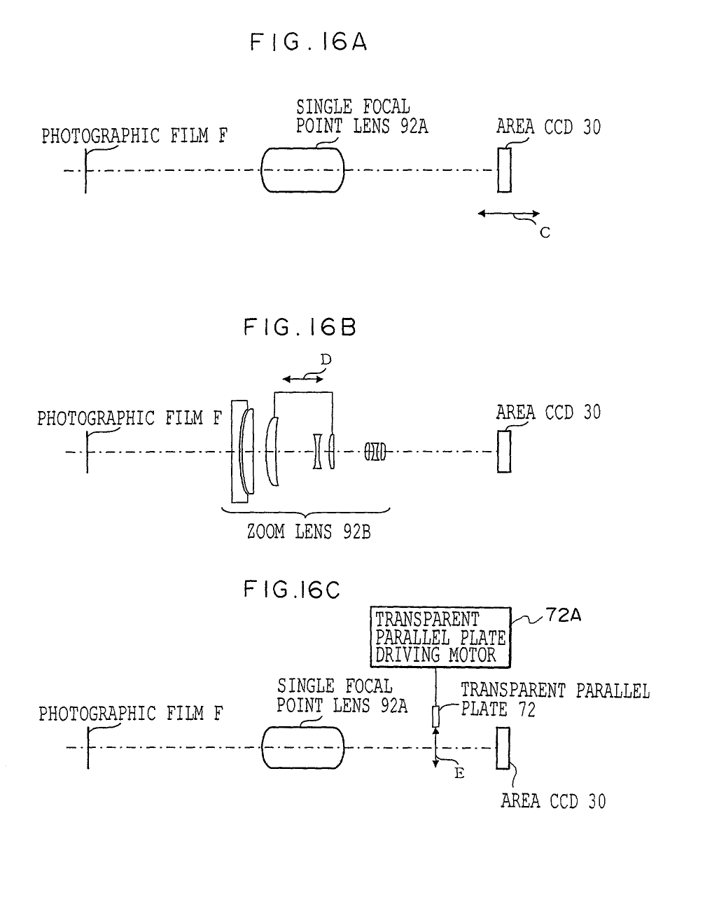

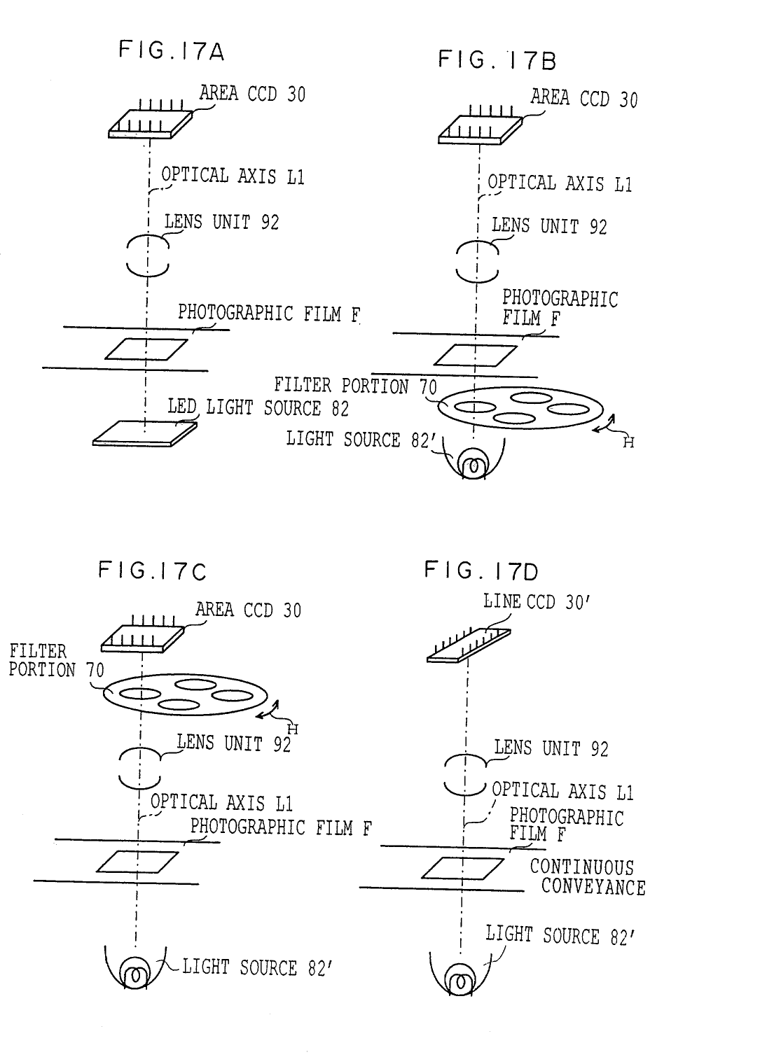

In each of the above-described embodiments, cases are described in which, as shown in FIG. 17A, the light source section 80, which is equipped with the LED light source 82 formed by the large number of LED elements 102 being arrayed two-dimensionally, is used as the illuminating section of the present invention, and the area CCD 30 is used as the image sensor of the present invention. However, the present invention is not limited to the same, and the examples shown in FIGS. 17B through 17D can be applied.

Namely, in the example shown in FIG. 17B, the illuminating section of the present invention is a white light source 82′ such as a halogen lamp, a metal halide lamp or the like, and a filter portion 70 which is provided between the white light source 82′ and the photographic film F and is equipped with a plurality of filters which color-separate the light emitted from the white light source 82′ such that lights of the respective colors of R, G, B and IR can be emitted. In FIG. 17B, by rotating, in the directions of arrow H, the filter portion 70 which is formed in a circular shape, the center of the corresponding filter is positioned so as to substantially coincide with the optical axis L1, such that the lights of the respective colors of R, G, B and IR are emitted.

Further, the example shown in FIG. 17C is an example in which the filter section 70 of the example shown in FIG. 17B is positioned between the lens unit 92 and the area CCD 30.

In the example shown in FIG. 17D, the white light source 82′ or LED light source 82), such as a halogen lamp or a metal halide lamp or the like, is used as the illuminating section of the present invention. Further, a line (linear) CCD, in which is incorporated filters which can color-separate the incident light such that lights of the respective colors of R, G, B and IR can be emitted, is used as the image sensor of the present invention.

In these cases as well, the same effects as those of the above-described embodiments can be achieved.

As described above in detail, in accordance with the image reading device and image reading method relating to the present invention, at each of a time of image reading by visible light and image reading by infrared light, control is effected such that focus control is carried out to make the imaging position by the imaging section and the reading position of the image sensor coincide. Thus, by merely controlling an imaging section, amoving section and the like which are provided in conventional image reading devices, sharp and clear image can be obtained for both image data obtained by image reading by visible light and image data obtained by image reading by infrared light. Further, a structure which is inexpensive and requires little space can be provided, and high quality image reading can be carried out by simple control.

What is claimed is:

1. An image reading device comprising:
an illuminating section which emits visible light and infrared light and illuminates an original;
an imaging section which images one of light transmitted through the original and light reflected by the original;
an image sensor which divides an image imaged by the imaging section into a plurality of pixels and reads the image and outputs the image as image data;
a moving section which moves at least one of at least one portion of the imaging section, the image sensor, and the original, in an optical axis direction of the imaging section; and
a control section which, at each of a time of reading the image by the visible light and a time of reading the image by the infrared light, controls the moving section such that focus control is carried out by which an imaging position by the imaging section and a reading position of the image sensor coincide.

2. An image reading device according to claim 1, wherein on the basis of image data obtained by reading the image by the infrared light, the control section detects a position of at least one of scratch and foreign matter on the original, and on the basis of results of detection, corrects image data obtained by reading the image by the visible light.

3. An image reading device according to claim 2, wherein before correction of the image data obtained by reading the image by the visible light, the control section carries out at least one of magnification chromatic aberration correction and distortion aberration correction on the image data obtained by reading the image by the infrared light.

4. An image reading device according to claim 2, wherein before correction of the image data obtained by reading the image by the visible light, the control section detects an image positional offset amount between the image data obtained by reading the image by infrared light and the image data obtained by reading the image by the visible light, and, on the basis of the positional offset amount, corrects one of the image data obtained by reading the image by the infrared light or the image data obtained by reading the image by the visible light such that the positional offset amount becomes minimum.

5. An image reading device according to claim 3, wherein before correction of the image data obtained by reading the image by the visible light, the control section detects an image positional offset amount between the image data obtained by reading the image by infrared light and the image data obtained by reading the image by the visible light, and, on the basis of the positional offset amount, corrects one of the image data obtained by reading the image by the infrared light or the image data obtained by reading the image by the visible light such that the positional offset amount becomes minimum.

6. An image reading device according to claim 4, wherein the control section one of
detects the positional offset amount in advance, and each time the image is read, corrects, on the basis of the positional offset amount, one of the image data obtained by reading the image by the infrared light and the image data obtained by reading the image by the visible light such that the positional offset amount becomes minimum, and
each time the image is read, detects the positional offset amount, and corrects, on the basis of the positional offset amount, one of the image data obtained by reading the image by the infrared light and the image data obtained by reading the image by the visible light such that the positional offset amount becomes minimum.

7. An image reading device according to claim 1, wherein the control section acquires in advance a focus position for a time of image reading by the visible light and a focus position for a time of image reading by the infrared light, by controlling the illuminating section and the moving section such that focus control in a case using each the visible light and the infrared light is carried out, and
controls the moving section such that, at each time reading the image recorded on the original by the respective visible light and infrared light, at least one of at least one portion of the imaging section, the image sensor and the original moves to each position which is based on the respective focus positions acquired in advance.

8. An image reading device according to claim 1, wherein the control section acquires in advance a focus position for a time of image reading by one of the visible light and the infrared light, by controlling the illuminating section and the moving section such that focus control in a case using the one of the visible light and the infrared light is carried out, and
controls the moving section such that, at a time of reading the image by the one of the visible light and the infrared light, at least one of at least one portion of the imaging section, the image sensor and the original moves to a position which is based on the focus position acquired in advance, and controls the moving section such that, at a time of reading the image by the another of the visible light and the infrared light, at least one of at least one portion of the imaging section, the image sensor and the original moves to a position which is offset, by a predetermined offset amount which is based on a design value of the imaging section, from the position which is based on the focus position acquired in advance.

9. An image reading device according to claim 1, wherein the at least one portion of the imaging section is, in a case in which the imaging section is formed to include a single focal point lens, the single focal point lens, or is, in a case in which the imaging section is formed to include a zoom lens, at least one portion of the zoom lens.

10. An image reading device according to claim 1, wherein the imaging section is provided with a transparent parallel plate which can change the imaging position by the imaging section by being inserted onto and withdrawn from a position on an optical axis of the imaging section, and
the moving section inserts the transparent parallel plate onto and withdraws the transparent parallel plate from the position on the optical axis of the imaging section.

11. An image reading device according to claim 1, wherein the illuminating section one of
illuminates the original by selectively emitting the visible light and the infrared light, and
illuminates the original by simultaneously emitting the visible light and the infrared light.

12. An image reading device comprising:
an illuminating section which emits visible light and infrared light and illuminates an original;
an imaging section which images one of light transmitted through the original and light reflected by the original, the imaging section being provided with a transparent parallel plate which can change an imaging position by being inserted onto and withdrawn from a position on an optical axis of the imaging section;
an image sensor which divides an image imaged by the imaging section into a plurality of pixels and reads the image and outputs the image as image data;
a moving section which inserts the transparent parallel plate onto and withdraws the transparent parallel plate from the position on the optical axis of the imaging section; and
a control section which, at each of a time of reading the image by the visible light and a time of reading the image by the infrared light, controls the moving section such that focus control is carried out by which the imaging position by the imaging section and a reading position of the image sensor coincide.

13. An image reading method which illuminates visible light and infrared light onto an original, and reads an image recorded on the original on the basis of one of light transmitted through the original and light reflected by the original, the image reading method comprising the step of:
at each of a time of reading the image by the visible light and a time of reading the image by the infrared light, effecting control to move at least one of at least one portion of an imaging section which images one of the light transmitted through the original and the light reflected by the original, an image sensor which divides an image imaged by the imaging section into a plurality of pixels and reads the image and outputs the image as image data, and the original, in an optical axis direction of the imaging section, such that focus control is carried out by which an imaging position by the imaging section and a reading position of the image sensor coincide.

14. An image reading method according to claim 13, wherein on the basis of image data obtained by reading the image by the infrared light, a position of at least one of scratch and foreign matter on the original is detected, and on the basis of results of detection, image data obtained by reading the image by the visible light is corrected.

15. An image reading method according to claim 14, wherein before correction of the image data obtained by reading the image by the visible light, at least one of magnification chromatic aberration correction and distortion aberration correction is carried out on the image data obtained by reading the image by the infrared light.

16. An image reading method according to claim 14, wherein before correction of the image data obtained by reading the image by the visible light, an image positional offset amount between the image data obtained by reading the image by infrared light and the image data obtained by reading the image by the visible light, is detected, and, on the basis of the positional offset amount, one of the image data obtained by reading the image by the infrared light or the image data obtained by reading the image by the visible light is corrected such that the positional offset amount becomes minimum.

17. An image reading method according to claim 15, wherein before correction of the image data obtained by reading the image by the visible light, an image positional offset amount between the image data obtained by reading the image by infrared light and the image data obtained by reading the image by the visible light, is detected, and, on the basis of the positional offset amount, one of the image data obtained by reading the image by the infrared light or the image data obtained by reading the image by the visible light is corrected such that the positional offset amount becomes minimum.

18. An image reading method according to claim 16, wherein one of
detecting the positional offset amount in advance, and each time the image is read, correcting, on the basis of the positional offset amount, one of the image data obtained by reading the image by the infrared light and the image data obtained by reading the image by the visible light such that the positional offset amount becomes minimum, and
each time the image is read, detecting the positional offset amount, and correcting, on the basis of the positional offset amount, one of the image data obtained by reading the image by the infrared light and the image data obtained by reading the image by the visible light such that the positional offset amount becomes minimum, is performed.

19. An image reading method according to claim 13, wherein a focus position for a time of image reading by the visible light and a focus position for a time of image reading by the infrared light are acquired in advance, by controlling illuminating of the visible light and the infrared light and moving of at least one of at least one portion of the imaging section, the image sensor and the original such that focus control in a case using each the visible light and the infrared light is carried out, and
at each time reading the image recorded on the original by the respective visible light and infrared light, at least one of at least one portion of the imaging section, the image sensor and the original is controlled to move to each position which is based on the respective focus positions acquired in advance.

20. An image reading method according to claim 13, wherein a focus position for a time of image reading by one of the visible light and the infrared light is acquired in advance, by controlling illuminating of the visible light and the infrared light and moving of at least one of at least one portion of the imaging section, the image sensor and the original such that focus control in a case using the one of the visible light and the infrared light is carried out, and
at a time of reading the image by the one of the visible light and the infrared light, at least one of at least one portion of the imaging section, the image sensor and the original is controlled to move to a position which is based on the focus position acquired in advance, and at a time of reading the image by the another of the visible light and the infrared light, at least one of at least one portion of the imaging section, the image sensor and the original is controlled to move to a position which is offset, by a predetermined offset amount which is based on a design value of the imaging section, from the position which is based on the focus position acquired in advance.

21. An image reading method according to claim 13, wherein the at least one portion of the imaging section is, in a case in which the imaging section is formed to include a single focal point lens, the single focal point lens, or is, in a case in which the imaging section is formed to include a zoom lens, at least one portion of the zoom lens.

22. An image reading method according to claim 13, wherein the imaging section is provided with a transparent parallel plate which can change the imaging position by the imaging section by being inserted onto and withdrawn from a position on an optical axis of the imaging section, and
inserting the transparent parallel plate onto and withdrawing the transparent parallel plate from the position on the optical axis of the imaging section is controlled.

23. An image reading method according to claim 13, wherein the visible light and the infrared light are illuminated to the original by one of selectively emitting and simultaneously emitting.

24. An image reading method which illuminates visible light and infrared light onto an original, and reads an image recorded on the original on the basis of one of light transmitted through the original and light reflected by the original, the image reading method comprising the 'step of:
at each of a time of reading the image by the visible light and a time of reading the image by the infrared light, effecting control to move a transparent parallel plate which is provided at an imaging section imaging one of the light transmitted through the original and the light reflected by the original on an image sensor which divides an image imaged by the imaging section into a plurality of pixels and reads the image and outputs the image as image data and which can change an imaging position by being inserted onto and withdrawn from a position on an optical axis of the imaging section, such that focus control is carried out by which the imaging position by the imaging section and a reading position of the image sensor coincide.
